(19) United States
(12) Patent Application Publication
(10) Pub. No.: US 2007/0237641 A1
(43) Pub. Date: Oct. 11, 2007

(54) Adjustable angle fan

(76) Inventor: Tawei Tsao, Diamond Bar, CA (US)

Correspondence Address: JOE NIEH, 18760 E. AMAR ROAD #204, WALNUT, CA, 91789, US

(21) Appl. No.: 11/400,703

(22) Filed: Apr. 6, 2006

(51) Int. Cl. B64C 27/00

(52) U.S. Cl. 416/170 R

(57) ABSTRACT

The adjustable angle fan comprises of a base with a mounting post to which is mounted a motor housing with an enclosed electric motor. The control for the fan speed is generally located in the base but may alternatively be positioned on the mounting post. The fan is affixed to one end of the electric motor axle. A fan cage is mounted to the motor housing and encloses the fan blades. A reduction gear box is affixed to the other end of the electric motor axle. The reduction gear box conveys the torque from the electric motor at a reduced rotational speed to a vertical axle extending generally below the electric motor. The adjustable mechanism is mounted at or near the bottom end of the vertical axle. The adjustable mechanism comprises of a movable pin that can be positioned at various locations to vary its distance from the vertical axle. A pivoting arm connects the movable pin to a fixed post on the base near the motor housing mounting post. The oscillating angle of the fan is varied depending on the distance of the movable pin from the vertical axle. The end user only needs to adjust the movable pin's location to adjust the oscillating angle of the fan.

### BACKGROUND

1. Field of Invention

The present invention relates generally to an oscillating electric fan. More specifically, the present invention relates to a mechanism for adjusting the oscillating angle of an oscillating electric fan.

2. Description of Related Art

Conventional oscillating electric fan generally comprises of a base with a mounting post to which is mounted a motor housing. The control for the fan speed is generally located in the base. The fan, generally comprises of plastic fan blades but may also be made of metal, is affixed to one end of the electric motor axle. A fan cage is mounted to the motor housing and encloses the fan blades. A reduction gear box is affixed to the other end of the electric motor axle. The reduction gear box conveys the torque from the electric motor at a reduced rotational speed to a small disc generally located under the electric motor. A pin is affixed at a fixed radius from the center of the disc. A pivoting arm connects the pin to a fixed post on the base near the motor housing mounting post. As the electric motor is activated, the fan blades would rotate and generate air movement. The disc under the motor housing would also rotate, although at a much slower rotational speed, and oscillate the motor housing. This results in an electric fan that would move its head left and right through a predetermined fixed arc. Traditionally, only the speed of the electric motor, thereby, the rotational speed of the fan, can be adjusted by the end user.

Furthermore, the relatively simplistic design and small number of parts in the conventional oscillating electric fan results in low manufacturing cost and retail price of the product. Therefore, to maintain the competitiveness and low cost of the design, any modification would necessarily require minimal changes to the existing structure and design of the oscillating electric fan and with the least number of parts required.

### BRIEF SUMMARY OF THE INVENTION

The present invention is an adjustable mechanism for adjustable angle fan. The mechanism would enable the adjustable angle fan to oscillate at multiple oscillating angles controllable by the end user. Furthermore, certain embodiments of the present invention would enable infinite adjustment of the angle of oscillating. The adjustable mechanism is simple to operate and is reliable due to the minimal number of parts. The adjustable mechanism has relatively few parts and generally has a simple design to minimize changes to existing structure and to enable low production costs. The adjustable mechanism will enable the production of the adjustable angle oscillating electric fans at virtually the same cost as conventional oscillating electric fans and with virtually the same number of parts in the product.

The adjustable angle fan comprises of a base with a mounting post to which is mounted a motor housing with an enclosed electric motor. The control for the fan speed is generally located in the base. The control may also be positioned on the mounting post. The fan is affixed to one end of the electric motor axle. A fan cage is mounted to the motor housing and encloses the fan blades. A reduction gear box is affixed to the other end of the electric motor axle. The reduction gear box conveys the torque from the electric motor at a reduced rotational speed to a vertical axle extending generally below the electric motor. The adjustable mechanism is mounted at or near the bottom end of the vertical axle.

The adjustable mechanism comprises of a movable pin that can be positioned at various locations to vary its distance from the vertical axle. A pivoting arm connects the movable pin to a fixed post on the base near the motor housing mounting post. As the electric motor is activated, the fan blades would rotate and generate air movement. The vertical axle would also rotate, although at a much slower rotational speed, and oscillate the motor housing and the fan. The oscillating angle of the fan is varied depending on the distance of the movable pin from the vertical axle. The end user only needs to adjust the movable pin's location to adjust the oscillating angle of the fan.

### BRIEF DESCRIPTION OF THE DRAWINGS

FIG. 1 shows a side view of a conventional free-standing oscillating electric fan.

FIG. 2 shows a rear view of a conventional free-standing oscillating electric fan.

FIG. 3 shows a side view of the preferred embodiment of the adjustable mechanism when the adjustable angle fan's oscillating movement is stopped by pulling up on the control knob.

FIG. 4 shows a side view of the preferred embodiment of the adjustable mechanism in the adjustable angle fan's operating position where the control is pushed down to its first control position wherein the oscillating movement is activated.

FIG. 5 shows a side view of the preferred embodiment of the adjustable mechanism where the control is pushed down to its second control position wherein the movable pin is being moved to another position to adjust the oscillating angle of the fan.

FIG. 6 shows the bottom view of the adjustment plate in the preferred embodiment of the adjustable mechanism.

FIG. 7 shows a perspective view of another embodiment of the adjustable mechanism.

FIG. 8 shows a bottom view of the embodiment of the adjustable mechanism shown in FIG. 7.

FIG. 9 shows a side view of the embodiment of the adjustable mechanism shown in FIG. 7.

FIG. 10 shows a perspective view of another embodiment of the adjustable mechanism.

FIG. 11 shows a bottom view of the embodiment of the adjustable mechanism shown in FIG. 10.

FIG. 12 shows a side view of the embodiment of the adjustable mechanism shown in FIG. 10.

FIG. 13 shows a perspective view of another embodiment of the adjustable mechanism.

FIG. 14 shows a bottom view of the embodiment of the adjustable mechanism shown in FIG. 13.

FIG. 15 shows a side view of the embodiment of the adjustable mechanism shown in FIG. 13.

FIG. 16 shows a perspective view of another embodiment of the adjustable mechanism.

FIG. 17 shows a bottom view of the embodiment of the adjustable mechanism shown in FIG. 16.

FIG. 18 shows a side view of the embodiment of the adjustable mechanism shown in FIG. 16.

FIG. 19 shows a perspective view of another embodiment of the adjustable mechanism in a first operating position.

FIG. 20 shows a side view of the embodiment of the adjustable mechanism shown in FIG. 19.

FIG. 21 shows a perspective view of the embodiment of the adjustable mechanism shown in FIG. 19 in a second adjusting position.

FIG. 22 shows a side view of the embodiment of the adjustable mechanism shown in FIG. 21.

FIG. 23 shows a perspective view of another embodiment of the adjustable mechanism.

FIG. 24 shows a top view of the embodiment of the adjustable mechanism shown in FIG. 25.

FIG. 25 shows a side view of the embodiment of the adjustable mechanism shown in FIG. 25.

FIG. 26 shows a perspective view of another embodiment of the adjustable mechanism in a second adjusting position.

FIG. 27 shows a side view of the embodiment of the adjustable mechanism shown in FIG. 26.

FIG. 28 shows a perspective view of the embodiment of the adjustable mechanism shown in FIG. 26 in a first operating position.

FIG. 29 shows a side view of the embodiment of the adjustable mechanism shown in FIG. 28.

FIG. 30 shows a bottom view of the embodiment of the adjustable mechanism shown in FIG. 29.

FIG. 31 shows a perspective view of another embodiment of the adjustable mechanism.

FIG. 32 shows a top view of the embodiment of the adjustable mechanism shown in FIG. 31.

FIG. 33 shows a side view of the embodiment of the adjustable mechanism shown in FIG. 31.

FIG. 34 shows a perspective view of another embodiment of the adjustable mechanism.

FIG. 35 shows a top view of the embodiment of the adjustable mechanism shown in FIG. 34.

FIG. 36 shows a side view of the embodiment of the adjustable mechanism shown in FIG. 34.

FIG. 37 shows a perspective view of another embodiment of the adjustable mechanism.

FIG. 38 shows a top view of the embodiment of the adjustable mechanism shown in FIG. 37.

FIG. 39 shows a side view of the embodiment of the adjustable mechanism shown in FIG. 37.

FIG. 40 shows a perspective view of another embodiment of the adjustable mechanism.

FIG. 41 shows a front view of the embodiment of the adjustable mechanism shown in FIG. 40.

FIG. 42 shows a side view of the embodiment of the adjustable mechanism shown in FIG. 40.

FIG. 43 shows a perspective view of another embodiment of the adjustable mechanism.

FIG. 44 shows a side view of the embodiment of the adjustable mechanism shown in FIG. 43.

FIG. 45 shows a bottom view of the embodiment of the adjustable mechanism shown in FIG. 43.

FIG. 46 shows a perspective view of another embodiment of the adjustable mechanism.

FIG. 47 shows a side view of the embodiment of the adjustable mechanism shown in FIG. 46.

FIG. 48 shows a bottom view of the embodiment of the adjustable mechanism shown in FIG. 46.

FIG. 49 shows a perspective view of another embodiment of the adjustable mechanism.

FIG. 50 shows a side view of the embodiment of the adjustable mechanism shown in FIG. 49.

FIG. 51 shows a bottom view of the embodiment of the adjustable mechanism shown in FIG. 49.

FIG. 52 shows a perspective view of another embodiment of the adjustable mechanism.

FIG. 53 shows a side view of the embodiment of the adjustable mechanism shown in FIG. 52.

FIG. 54 shows a perspective view of another embodiment of the adjustable mechanism.

FIG. 55 shows a side view of the embodiment of the adjustable mechanism shown in FIG. 54.

FIG. 56 shows a perspective view of another embodiment of the adjustable mechanism.

FIG. 57 shows a side view of the embodiment of the adjustable mechanism shown in FIG. 56.

FIG. 58 shows a perspective view of another embodiment of the adjustable mechanism.

FIG. 59 shows a side view of the embodiment of the adjustable mechanism shown in FIG. 58.

FIG. 60 shows a top view of the embodiment of the adjustable mechanism shown in FIG. 58.

FIG. 61 shows a perspective view of another embodiment of the adjustable mechanism.

FIG. 62 shows a side view of the embodiment of the adjustable mechanism shown in FIG. 61.

FIG. 63 shows a top view of the embodiment of the adjustable mechanism shown in FIG. 61.

FIG. 64 shows a perspective view of another embodiment of the adjustable mechanism.

FIG. 65 shows a side view of the embodiment of the adjustable mechanism shown in FIG. 64.

FIG. 66 shows a perspective view of another embodiment of the adjustable mechanism.

FIG. 67 shows a side view of the embodiment of the adjustable mechanism shown in FIG. 66.

FIG. 68 shows a perspective view of another embodiment of the adjustable mechanism.

FIG. 69 shows a side view of the embodiment of the adjustable mechanism shown in FIG. 68.

FIG. 70 shows a perspective view of another embodiment of the adjustable mechanism.

FIG. 71 shows a side view of the embodiment of the adjustable mechanism shown in FIG. 70.

FIG. 72 shows a perspective view of another embodiment of the adjustable mechanism.

FIG. 73 shows a side view of the embodiment of the adjustable mechanism shown in FIG. 72.

FIG. 74 shows a perspective view of another embodiment of the adjustable mechanism.

FIG. 75 shows a side view of the embodiment of the adjustable mechanism shown in FIG. 74.

FIG. 76 shows a perspective view of another embodiment of the adjustable mechanism.

FIG. 77 shows a side view of the embodiment of the adjustable mechanism shown in FIG. 76.

FIG. 78 shows a perspective view of another embodiment of the adjustable mechanism.

FIG. 79 shows a side view of the embodiment of the adjustable mechanism shown in FIG. 78.

FIG. 80 shows a perspective view of another embodiment of the adjustable mechanism in a first position.

FIG. 81 shows a side view of the embodiment of the adjustable mechanism shown in FIG. 80.

FIG. 82 shows a perspective view of another embodiment of the adjustable mechanism in the second position wherein the movable pin is being moved to another position to adjust the oscillating angle of the fan.

FIG. 83 shows a side view of the embodiment of the adjustable mechanism shown in FIG. 82.

FIG. 84 shows a perspective view of another embodiment of the adjustable mechanism.

FIG. 85 shows a side view of the embodiment of the adjustable mechanism shown in FIG. 84.

FIG. 86 shows a perspective view of another embodiment of the adjustable mechanism.

FIG. 87 shows a side view of the embodiment of the adjustable mechanism shown in FIG. 86.

FIG. 88 shows a perspective view of another embodiment of the adjustable mechanism in a first position.

FIG. 89 shows a side view of the embodiment of the adjustable mechanism shown in FIG. 88.

FIG. 90 shows a perspective view of another embodiment of the adjustable mechanism in the second position.

FIG. 91 shows a side view of the embodiment of the adjustable mechanism shown in FIG. 90.

FIG. 92 shows a perspective view of another embodiment of the adjustable mechanism in a first position.

FIG. 93 shows a side view of the embodiment of the adjustable mechanism shown in FIG. 92.

FIG. 94 shows a perspective view of another embodiment of the adjustable mechanism in the second position.

FIG. 95 shows a side view of the embodiment of the adjustable mechanism shown in FIG. 94.

FIG. 96 shows a perspective view of another embodiment of the adjustable mechanism.

FIG. 97 shows a side view of the embodiment of the adjustable mechanism shown in FIG. 96.

FIG. 98 shows a perspective view of another embodiment of the adjustable mechanism.

FIG. 99 shows a side view of the embodiment of the adjustable mechanism shown in FIG. 98.

FIG. 100 shows a perspective view of another embodiment of the adjustable mechanism.

FIG. 101 shows a side view of the embodiment of the adjustable mechanism shown in FIG. 100.

FIG. 102 shows a perspective view of another embodiment of the adjustable mechanism.

FIG. 103 shows a side view of the embodiment of the adjustable mechanism shown in FIG. 102.

FIG. 104 shows a perspective view of another embodiment of the adjustable mechanism.

FIG. 105 shows a side view of the embodiment of the adjustable mechanism shown in FIG. 104.

FIG. 106 shows a perspective view of another embodiment of the adjustable mechanism.

FIG. 107 shows a side view of the embodiment of the adjustable mechanism shown in FIG. 106.

FIG. 108 shows a perspective view of another embodiment of the adjustable mechanism.

FIG. 109 shows a side view of the embodiment of the adjustable mechanism shown in FIG. 108.

FIG. 110 shows cross section view A-A of the adjustable mechanism shown in FIG. 109.

FIG. 111 shows a perspective view of another embodiment of the adjustable mechanism.

FIG. 112 shows a side view of the embodiment of the adjustable mechanism shown in FIG. 111.

FIG. 113 shows a perspective view of another embodiment of the adjustable mechanism.

FIG. 114 shows a side view of the embodiment of the adjustable mechanism shown in FIG. 113.

FIG. 115 shows a side view of another embodiment of the adjustable mechanism.

FIG. 116 shows a perspective view of the embodiment of the adjustable mechanism shown in FIG. 115.

FIG. 117 shows a perspective view of another embodiment of the adjustable mechanism.

FIG. 118 shows a side view of the embodiment of the adjustable mechanism shown in FIG. 117.

FIG. 119 shows a perspective view of another embodiment of the adjustable mechanism.

FIG. 120 shows a side view of the embodiment of the adjustable mechanism shown in FIG. 119.

FIG. 121 shows a perspective view of another embodiment of the adjustable mechanism.

FIG. 122 shows a side view of the embodiment of the adjustable mechanism shown in FIG. 121.

FIG. 123 shows a perspective view of another embodiment of the adjustable mechanism.

FIG. 124 shows a side view of the embodiment of the adjustable mechanism shown in FIG. 123.

FIG. 125 shows a perspective view of another embodiment of the adjustable mechanism.

FIG. 126 shows a side view of the embodiment of the adjustable mechanism shown in FIG. 125.

FIG. 127 shows a perspective view of another embodiment of the adjustable mechanism.

FIG. 128 shows a side view of the embodiment of the adjustable mechanism shown in FIG. 127.

FIG. 129 shows a perspective view of another embodiment of the adjustable mechanism.

FIG. 130 shows a side view of the embodiment of the adjustable mechanism shown in FIG. 129.

FIG. 131 shows a perspective view of another embodiment of the adjustable mechanism.

FIG. 132 shows a side view of the embodiment of the adjustable mechanism shown in FIG. 131.

FIG. 133 shows a perspective view of another embodiment of the adjustable mechanism.

FIG. 134 shows a side view of the embodiment of the adjustable mechanism shown in FIG. 133.

FIG. 135 shows a perspective view of another embodiment of the adjustable mechanism.

FIG. 136 shows a side view of the embodiment of the adjustable mechanism shown in FIG. 135.

FIG. 137 shows a perspective view of an alternate embodiment of the movable pin.

FIG. 138 shows a side view of the embodiment of the movable pin shown in FIG. 137.

FIG. 139 shows a perspective view of another embodiment of the movable pin.

FIG. 140 shows a side view of the embodiment of the movable pin shown in FIG. 139.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

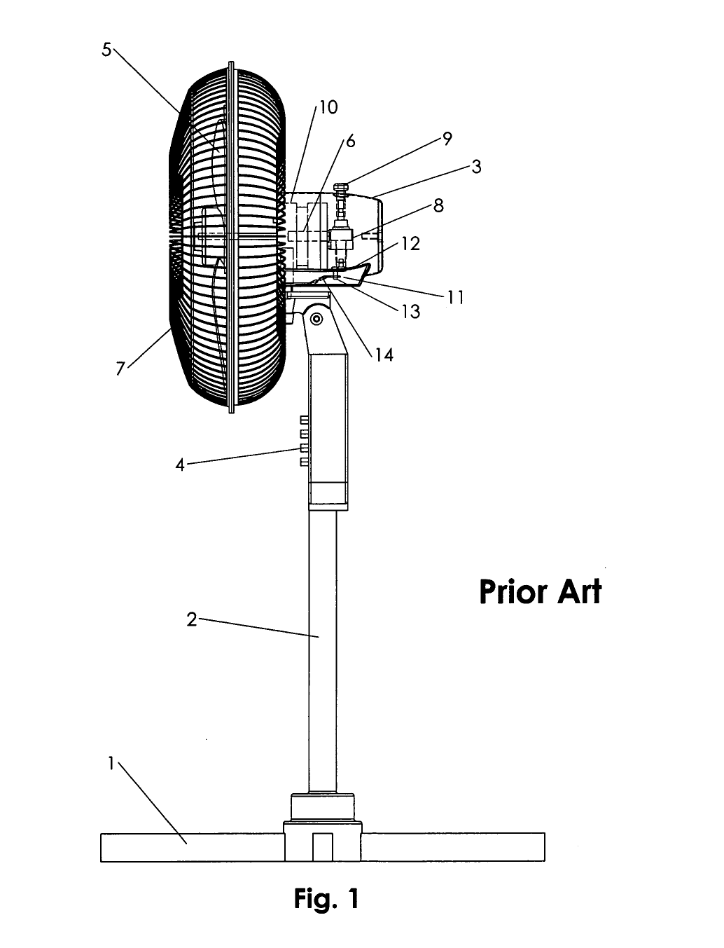

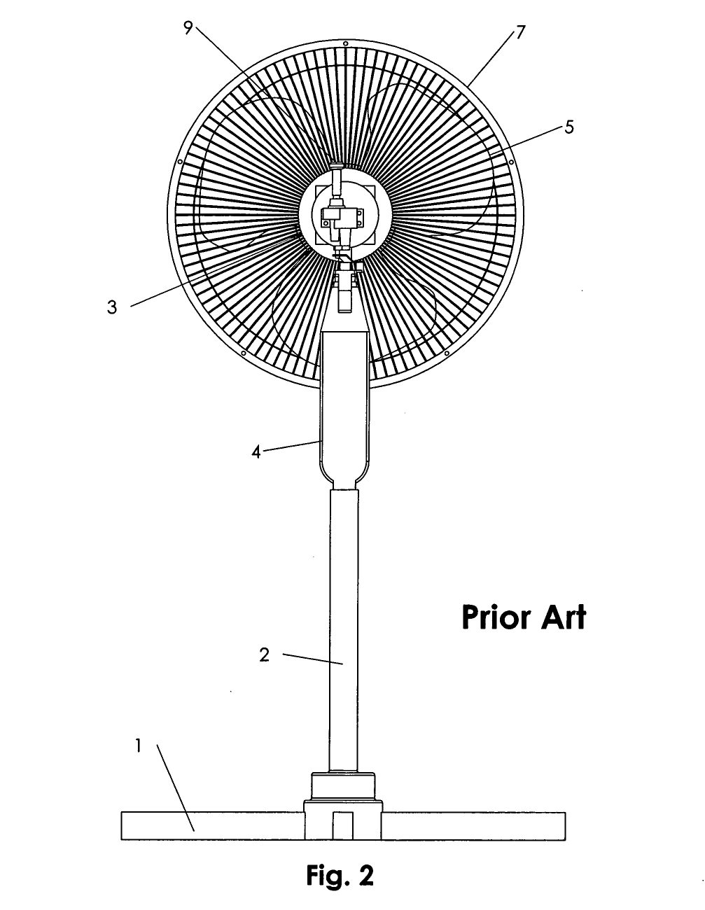

A conventional oscillating electric fan is shown in FIGS. 1 and 2. A conventional oscillating electric fan generally comprises of a base 1 with a mounting post 2 to which is mounted a motor housing 3. The control 4 for the fan speed is generally located in the base 1 but may alternatively be positioned on the mounting post 2. The fan 5 is affixed to one end of the electric motor axle 6. A fan cage 7 is mounted to the motor housing 3 and encloses the fan blades 5. A reduction gear box 8 is affixed to the other end of the electric motor axle 6. Extending from the top of the reduction gear box is a knob 9 for stopping the oscillation of the fan. When the knob 9 is pulled the transfer gear is disengaged from the electric motor 10 and the connection to the oscillating mechanism 11 is disengaged. The reduction gear box 8 conveys the torque from the electric motor 10 at a reduced rotational speed through a vertical axle 20 to the oscillating mechanism 11, which is a small disc 12 generally located under the electric motor 10. A pin 13 is affixed at a fixed radius from the center of the disc 12. A pivoting arm 14 connects the pin 13 to a fixed post on the base near the motor housing 3 mounting post 2. As the electric motor 10 is activated, the fan blades 5 would rotate and generate air movement. The disc 12 under the electric motor 10 would also rotate, although at a much slower rotational speed, and oscillate the motor housing 3.

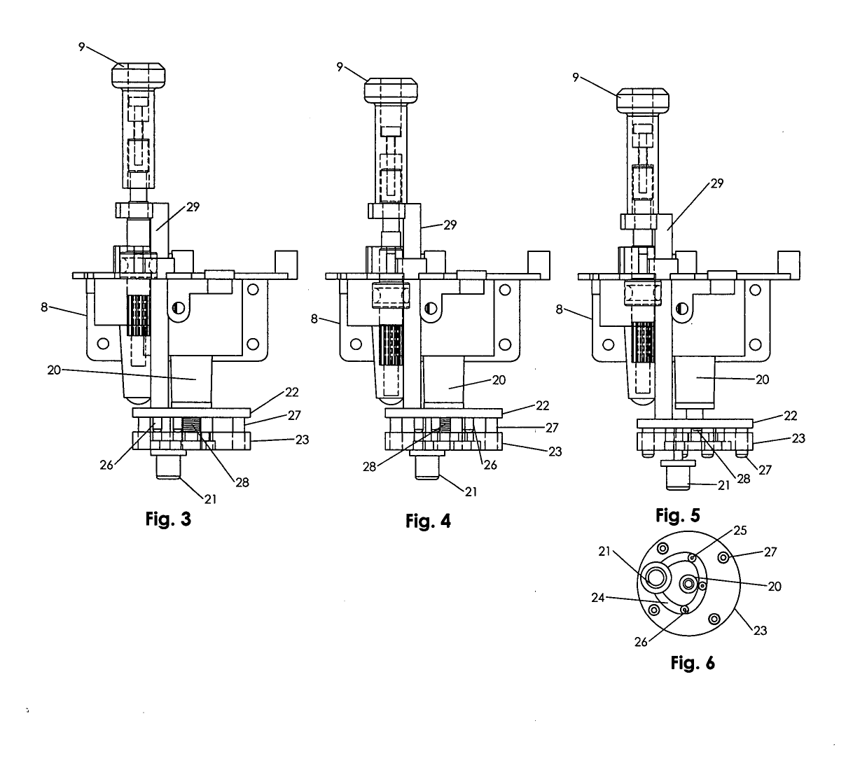

The present invention is an adjustable mechanism to change the oscillating angle of an adjustable angle fan. The adjustable mechanism is mounted at or near the bottom end of the vertical axle 20. In the preferred embodiment, as shown in FIGS. 3, 4, 5, and 6, the adjustable mechanism generally comprises of a movable pin 21 that can be positioned at various locations to vary its distance from the vertical axle 20. More specifically, the adjustable mechanism comprises of two discs 22, 23, a top disc 22 and a bottom disc 23. The bottom disc 23 has an offset circulating track 24 on its bottom surface. Within this circulating track 24 are multiple through holes 25 for the movable pin 21 to insert into. The top disc 22 is disposed directly on top of the bottom disc 23. Multiple corresponding posts 26 extend from the top disc 22 through the multiple through holes 25 in the circular track 24 in the bottom disc 23. In the rest position, where the adjustable mechanism is not being activated, the multiple posts 26 are positioned just above the multiple through holes 25 in the circular track 24. In the activated position, the multiple posts 26 will extend into the multiple through holes 25 in the circular track 24 until the tips of the posts 26 are flush with the bottom of the circular track 24. The multiple posts 26 may also protrude slightly from the bottom surface of the circular track 24. Each through hole 25 is positioned at a different distance from the center of the bottom disc 23. Multiple positioning posts 27 extend from the top disc 22 through the bottom disc 23 to align the orientation of the two discs 22, 23 and prevent rotation of one disc with respect to the other disc. A spring 28 is mounted between the two discs 22, 23, urging the separation of the two discs 22, 23. An actuating arm 29 extends from inside the knob 9 that extends from the top of the reduction gear box 8 to the top of the top disc 22. When the actuating arm 29 is depressed by pressing down on the knob 9, it would push the top disc 22 down. The multiple posts 26 would extend through the multiple through holes 25 in the circular track 24 in the bottom disc 23 thereby pushing the movable pin 21 out of the hole it is resting in. Upon release of the knob 9, the spring 28 will urge the two discs 22, 23 to separate and, thereby, pull the multiple posts 26 of the top disc 22 out of the multiple through holes 25 in the bottom disc 23. As the circular discs 22, 23 continue to rotate, the movable pin 21 would move inside the circulating track 24 to the next through hole 25 in the circular track 24. Since the radius of rotation has thus been changed, the angle of oscillation of the motor housing 3 has correspondingly been changed. The pivoting arm 14 is positioned such that it constantly exerts an upward force on the movable pin 21 to maintain the movable pin 21 within the circular track 24. This upward force may be simply from the flexing of the pivoting arm 14 or from a spring at the bottom or top of the other end of the pivoting arm 14, pushing or pulling the pivoting arm 14 upward.

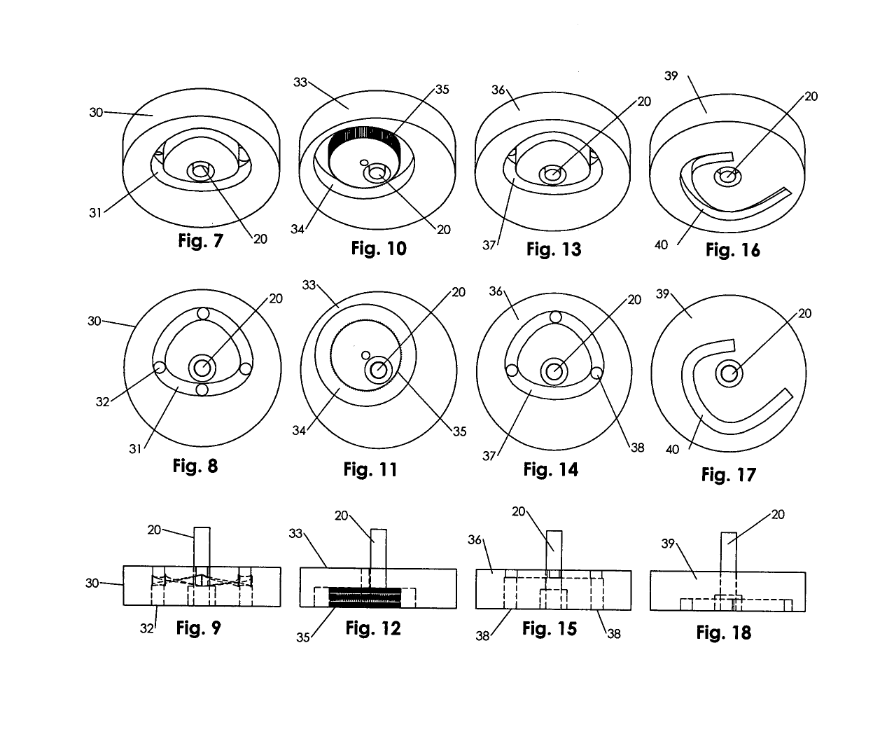

Another embodiment of the present invention is shown in FIGS. 7, 8, and 9. In this embodiment, a disc 30 is affixed to the bottom end of the vertical axle 20. The disc 30 has an offset circular track 31 on its bottom surface and multiple through holes 32 extending through the disc 30 from the bottom of the circular track 31. The section of the circular track 31 that leads from one through hole 32 to the next through hole 32 is tapered such that after the movable pin 21 is withdrawn from one through hole 32 it would slide to the next through hole 32, aided by the incline in the tapered track section, without delay. The through holes 32 are positioned at varying radiuses from the center of the vertical axle 20, therefore, various oscillating angles can be set by moving the movable pin 21 to the different through holes 32. This design will shorten the response time of the change in the angle of oscillation when the position of the movable pin 21 is changed.

Yet another embodiment of the present invention is shown in FIGS. 10, 11, and 12. In this embodiment, a disc 33 is affixed to the bottom end of the vertical axle 20. The disc 33 has an offset circular track 34 on its bottom surface. Within the wall of the circular track 34 is a gear surface 35 whereby corresponding gear teeth on the movable pin 21 is engaged to when the movable pin 21 is inserted into the circular track 34. When the movable pin 21 is rotated on its axis, the gear teeth on the movable pin 21 will engage the gear surface 35 in the circular track 34 thereby the movable pin 21 is moved along the circular track 21. As the movable pin 21 is moved to different positions within the circular track 21, the angle of oscillation is changed.

FIGS. 13, 14, and 15 show another embodiment of the present invention. In this embodiment, a disc 36 is affixed to the bottom end of the vertical axle 20. The disc 36 has an offset circular track 37 on its bottom surface and multiple through holes 38 extending through the disc 36 from the bottom of the circular track 37. When the movable pin 21 is withdrawn from one through hole 38 it will slide along the circular track 37 due to the rotation of the circular disc 36 and would, after a short moment, slide to the next through hole 38. The through holes 38 are positioned at varying radiuses from the center of the vertical axle 20, therefore, various oscillating angles can be set by moving the movable pin 21 to the different through holes 38. Alternatively, instead of the through holes 38, a ridged surface, similar to the embodiment in FIGS. 10, 11, and 12, may be formed at the bottom of the circular track 37. On the tip of the movable pin 21 is formed a matching set of ridges to engage the ridge surface at the bottom of the circular track 37. Instead of the ridge surface, the bottom of the circular track 37 may have indentations that will engage with corresponding one or more protrusions at the tip of the movable pin 21. A variation of this embodiment comprises of a circular track 37 with radial indentations in the form of rectangular cut-outs formed on its side wall. The movable pin 21 in this embodiment has a matching rectangular shoulder near its tip to engage the rectangular cut-outs in the circular track 37. In all these variations, the movable pin 21 is operated in the same way, i.e. when the movable pin 21 is pulled down it will disengage from the circular track 37 and slide along the circular track 37 due to the rotation of the circular disc 36 and would, after a short moment, slide to the next engagement point.

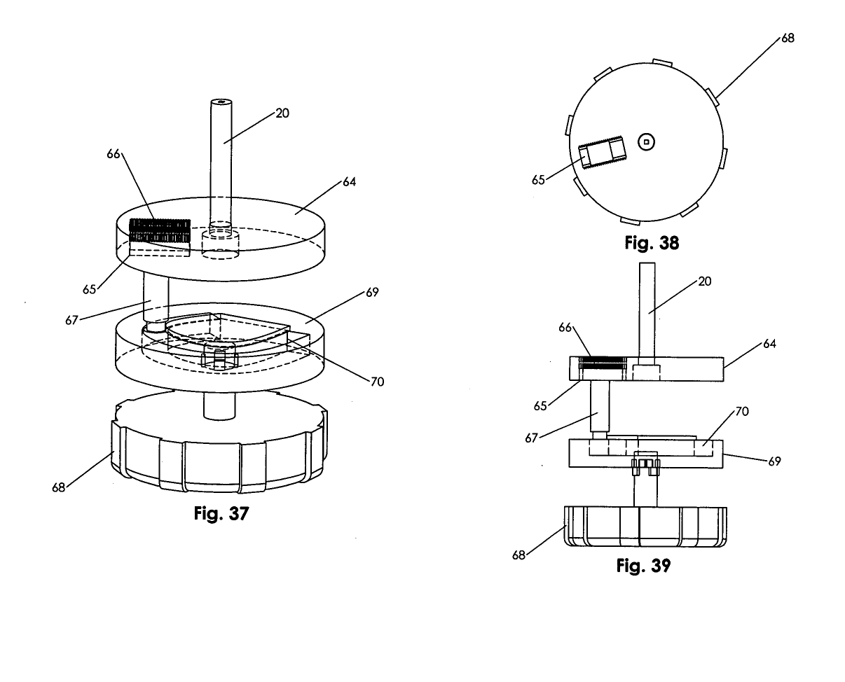

Another embodiment of the present invention is shown in FIGS. 16, 17, and 18. In this embodiment, a disc 39 is affixed to the bottom end of the vertical axle 20. The disc 39 has a track 40 in the form of an arc or a spiral on its bottom surface. The movable pin 21 is slidably retained within another track, preferably in the form of a radial slot, preferably straight without curvature, in another control disc, similar to the control disc shown in FIGS. 37 and 39. The control disc is rotably affixed under the disc 39 at the bottom of the vertical axle 20. As the control disc is rotated, the movable pin 21 will slide along the track 40. As the movable pin 21 is positioned at different locations along the track 40, the distance between the movable pin 21 and the vertical axle 20 is varied thereby changing the oscillating angle of the motor housing 3.

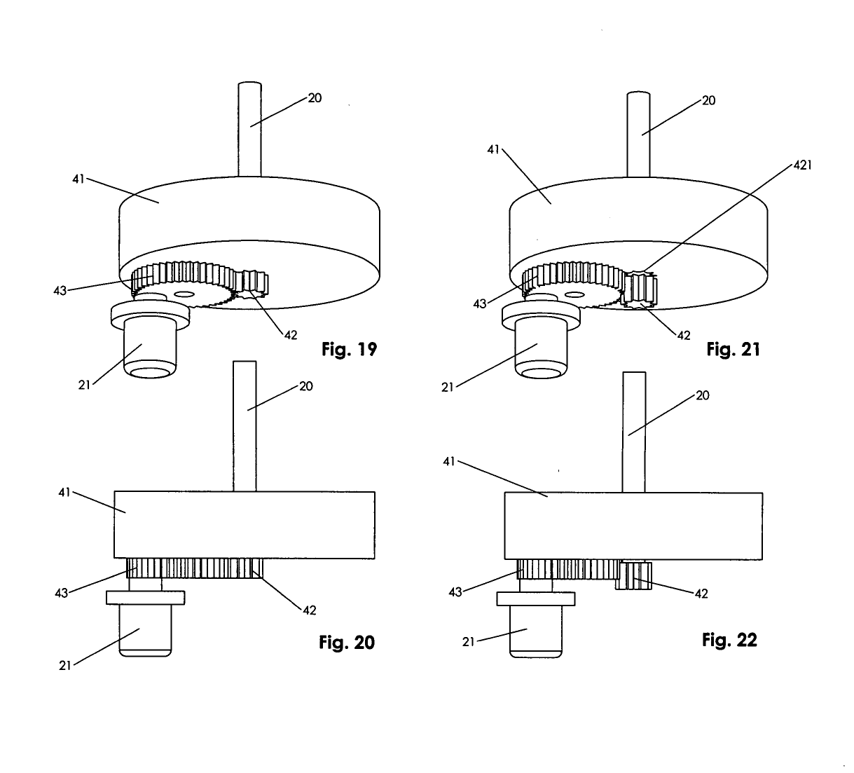

FIGS. 19, 20, 21, and 22 show another embodiment of the present invention. In this embodiment, a disc 41 or an elongated member with a through hole in its center with a slightly larger diameter than the vertical axle is rotably affixed to the bottom end of the vertical axle 20. The end of the vertical axle 20 has a small gear 42 that engages a gear-shaped cavity 421 in the bottom of the disc 41 or the elongated member. The gear-shaped cavity 421 only extends partially through the disc 41 or the elongated member and does not extend through the disc 41 or the elongated member but is of sufficient depth such that it will engage the small gear 42 without slipping. A larger gear 43 with the same pitch gear teeth as the small gear 42 is rotably affixed to the bottom surface of the disc 41 or elongated member and engages the small gear 42. The movable pin 21 is affixed to the bottom surface of this larger gear 43 at an offset location away from the center of the larger gear 43. To adjust the position of the movable pin 21 the vertical axle 20 is pressed down to disengage the small gear 42 from the gear-shaped cavity 421 in the bottom of the disc 41 or elongated member. Once the small gear 42 is disengaged from the gear-shaped cavity 421, the vertical axle 20 can be rotated which in turn rotates the small gear 42. The small gear 42 would rotate the larger gear 43. As the larger gear 43 is rotated, the distance of the movable pin 21 from the center of the vertical axle 20 is changed thereby changing the oscillating angle of the motor housing 3.

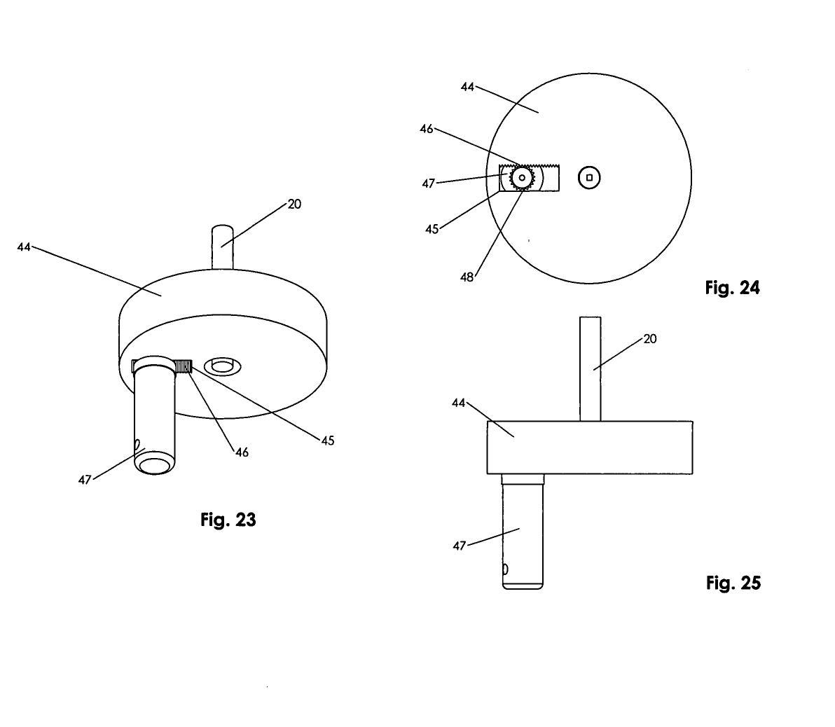

Another embodiment of the present invention is shown in FIGS. 23, 24, and 25. In this embodiment, a disc 44 is affixed to the bottom end of the vertical axle 20. The disc 44 has a radial slot track 45 through it with a rack gear 46 on one side of the slot track 45. A movable pin 47 with a pinion gear 48, with matching gear teeth as the rack gear 46, on one end is inserted in the slot track 45. When the movable pin 47 is rotated on its axis, the pinion gear teeth at the end of the movable pin 47 will engage the rack gear teeth in the slot track 45 thereby moving the movable pin 47 radially within the slot track 45. As the movable pin 47 is moved to different positions within the slot track 45, the angle of oscillation is changed. Alternatively, the disc 44 may be replaced with an elongated member with an elongated track along its length and with a rack gear on one side of the elongated track.

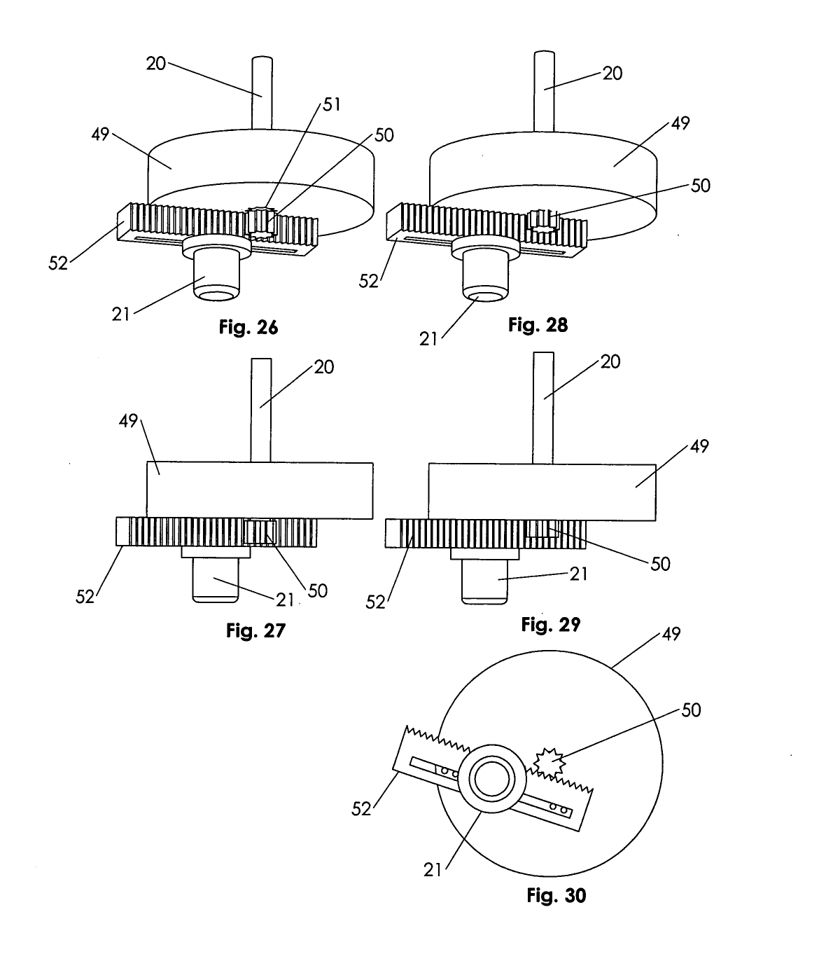

FIGS. 26, 27, 28, 29, and 30 show another embodiment of the present invention. In this embodiment, a disc 49 with a through hole in its center with a slightly larger diameter than the vertical axle 20 is rotably affixed to the bottom end of the vertical axle 20. The end of the vertical axle 20 has a small gear 50 that engages a gear-shaped cavity 51 in the bottom of the disc 49. The gear-shaped cavity 51 only extends partially through the disc 49 and does not extend through the disc 49 but is of sufficient depth such that it will engage the small gear 50 without slipping. A gear rack 52 with the same pitch gear teeth as the small gear 50 is slidably affixed to the bottom surface of the disc 49 and engages the small gear 50. The movable pin 21 is affixed to the bottom surface of this gear rack 52. To adjust the position of the movable pin 21 the vertical axle 20 is pressed down to disengage the small gear 50 from the gear-shaped cavity 51 in the bottom of the disc 49. Once the small gear 50 is disengaged from the gear-shaped cavity 51, the vertical axle 20 can be rotated which in turn rotates the small gear 50. The small gear 50 would move the gear rack 52 and change the distance between the movable pin 21 and the center of the vertical axle 20 thereby changing the oscillating angle of the motor housing 3.

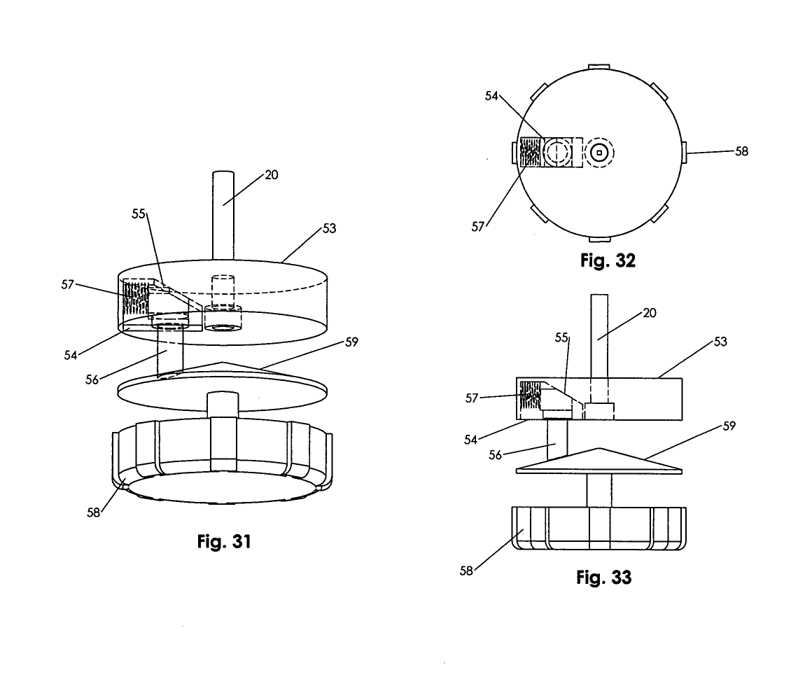

FIGS. 31, 32, and 33 show another embodiment of the present invention. In this embodiment, a disc 53 is affixed to the bottom end of the vertical axle 20. The disc 53 has an elongated slot 54 with a slanted top surface 55 tapering downward toward the center of the disc 53. The movable pin 56 has a top end that is slidably positioned within the elongated slot 54 and slides on the slanted top surface 55 in the elongated slot 54. A spring 57 is positioned between the top end of the movable pin 56 and one end of the elongated slot 54 to provide an urging force towards the center of the disc 53. A control knob 58 with a control surface 59 is positioned under the movable pin 56. The control surface 59 can be moved up or down with the control knob 58. The movement may be by rotating the control knob 58 which may have a screw-type stem that rotates in a fixed hole with matching screw threads to advance or retract the control surface 59 against the movable pin 56. The control surface 59 may be a flat planar surface or may be tapered in a conical shape rising from its edge to the center. As the control surface 59 is raised, the movable pin 56 is urged away from the center of the disc 53 due to the slanted top surface 55. As the control surface 59 is lowered, the spring 57 will urge the movable pin 56 to move towards the center of the disc 53. The oscillation angle will thereby be changed accordingly. Alternatively, the disc 53 may be replaced with an elongated member with an elongated slot. The other components remain unchanged and are structured in the same way.

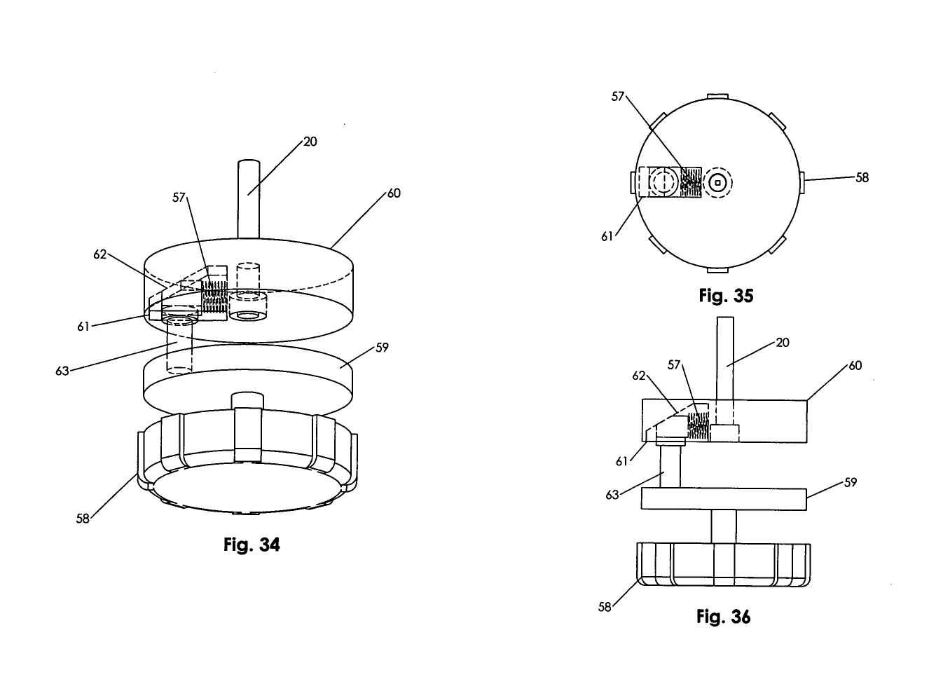

Another embodiment of the present invention is shown in FIGS. 34, 35, and 36. This embodiment is a slight variation of the embodiment shown in FIGS. 31, 32, and 33. In this embodiment, a disc 60 is affixed to the bottom end of the vertical axle 20. The disc 60 has an elongated slot 61 with a slanted top surface 62 tapering downward from the center of the disc 60 toward the edge of the disc 60. The movable pin 63 has a top end that is slidably positioned within the elongated slot 61 and slides on the slanted top surface 62 in the elongated slot 61. A spring 57 is positioned between the top end of the movable pin 63 and one end of the elongated slot 61 to provide an urging force towards the edge of the disc 60. A control knob 58 with a control surface 59 is positioned under the movable pin 63. The control surface 59 can be moved up or down with the control knob 58. The movement may be by rotating the control knob 58 which may have a screw-type stem that rotates in a fixed hole with matching screw threads to advance or retract the control surface 59 against the movable pin 63. The control surface 59 may be a flat planar surface or may be tapered in a reversed conical shape rising from its center to the edge. As the control surface 59 is raised, the movable pin 63 is urged toward the center of the disc 60 due to the slanted top surface 62. As the control surface 59 is lowered, the spring 57 will urge the movable pin 63 to move towards the edge of the disc 60. The oscillation angle will thereby be changed accordingly. Alternatively, the disc 60 may be replaced with an elongated member with an elongated slot. The other components remain unchanged and are structured in the same way.

FIGS. 37, 38, and 39 show another embodiment of the present invention. In this embodiment, a disc 64 is affixed to the bottom end of the vertical axle 20. The disc 64 has an elongated slot 65 oriented radially from the center of the disc 64 to near the edge of the disc 64. The top surface 66 of the slot 65 has teeth formed to match corresponding teeth on the top end of the movable pin 67. The movable pin 67 has a top end with teeth that engage the teeth in the top surface 66 of the slot 65 in the disc 64 and is slidable within the elongated slot 65 when the teeth are disengaged. A control knob 68 with a control surface 69 is positioned under the movable pin 67. The control surface 69 has a spiral track 70 with a shelf near its open top and can be rotated with the control knob 68. The bottom end of the movable pin 67 has a larger end that fits inside the spiral track 70 but is larger than the shelf such that it cannot be pulled out of the track 70 from the top and is slidably positioned within the spiral track 70. To move the movable pin 67, the control surface 69 is first pulled down to disengage the teeth at the top end of the movable pin 67 and then the control knob 68 is rotated. The movable pin 67 is urged to slide along the spiraling track 70 thereby changing its distance from the center of the disc. The oscillation angle will thereby be changed accordingly. Alternatively, the disc 64 may be replaced with an elongated member with a similar elongated slot as the disc 64. The other components remain unchanged and are structured in the same way.

In an alternate embodiment, instead of positioning the teeth on the top surface 66 of the slot 65, the teeth are positioned at the bottom ledge of the slot 65 to match corresponding teeth on the top end of the movable pin 67. The movable pin 67 has an enlarged top end with teeth at the shoulder of the enlarged end to engage the teeth at the bottom ledge of the slot 65 in the disc 64 and is slidable within the elongated slot 65 when the teeth are disengaged. To move the movable pin 67, the control surface 68 is first pushed up to disengage the teeth between the bottom ledge of the slot 65 and the shoulder of the enlarged end of the movable pin 67 and then the control knob 68 is rotated. The movable pin 67 is urged to slide along the spiraling track 70 thereby changing its distance from the center of the disc 64. The oscillation angle will thereby be changed accordingly.

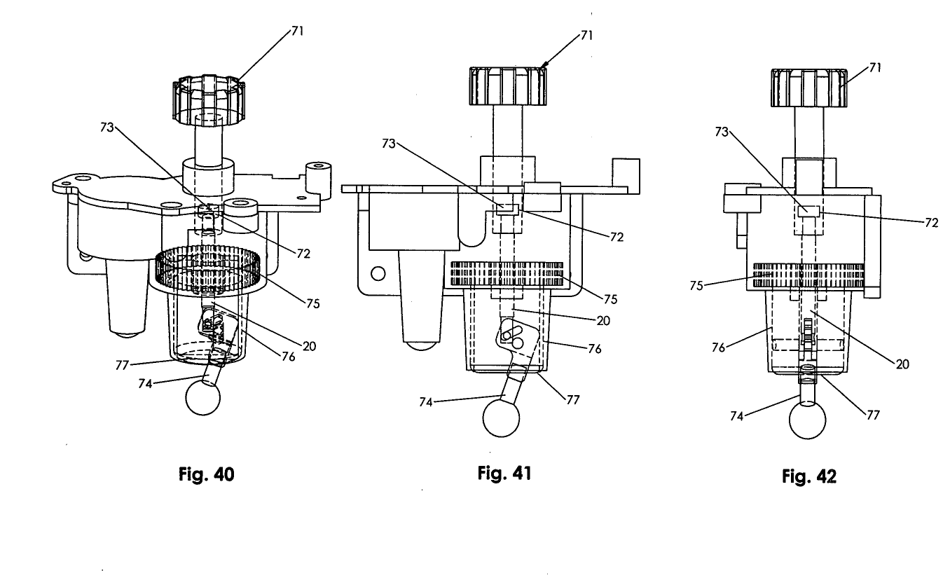

Another embodiment is shown in FIGS. 40, 41, and 42. In this embodiment, a free rotating control knob 71 is rotably connected to the top of the vertical axle 20. The control knob 71 does not rotate with the vertical axle 20 but is connected to the vertical axle 20 such that it can move the vertical axle 20 up and down in its axial direction. This may be accomplished with an enlarged circular terminal 72 in the form of a sphere or a disc at the top extremity of the vertical axle 20 which is received in a corresponding cavity 73 at the bottom of the control knob 71. A movable pin 74 is pivotally connected to the bottom of the vertical axle 20 such that as the vertical axle 20 is moved up and down in its axial direction, the movable pin 74 will pivot and change the distance between its extremity and the center of the vertical axle 20 thereby changing the oscillation angle. As the vertical axle 20 is pulled up by the control knob 71, the distance between the extremity of the movable pin 74 and the vertical axle 20 is reduced, thereby reducing the oscillation angle. As the vertical axle 20 is pushed down by the control knob 71, the distance between the extremity of the movable pin 74 and the vertical axle 20 is increased, thereby increasing the oscillation angle. When the extremity of the movable pin 74 is positioned directly under the vertical axle 20, the oscillation angle is reduced to zero, thereby essentially stopping the oscillation of the fan. The gear 75 that surrounds the vertical axle 20 has an extended cylindrical portion 76 in which a part of the movable pin 74 is disposed. At the bottom end of the extended cylindrical portion 76 is a slot opening 77 through which an extremity of the movable pin 74 extends through.

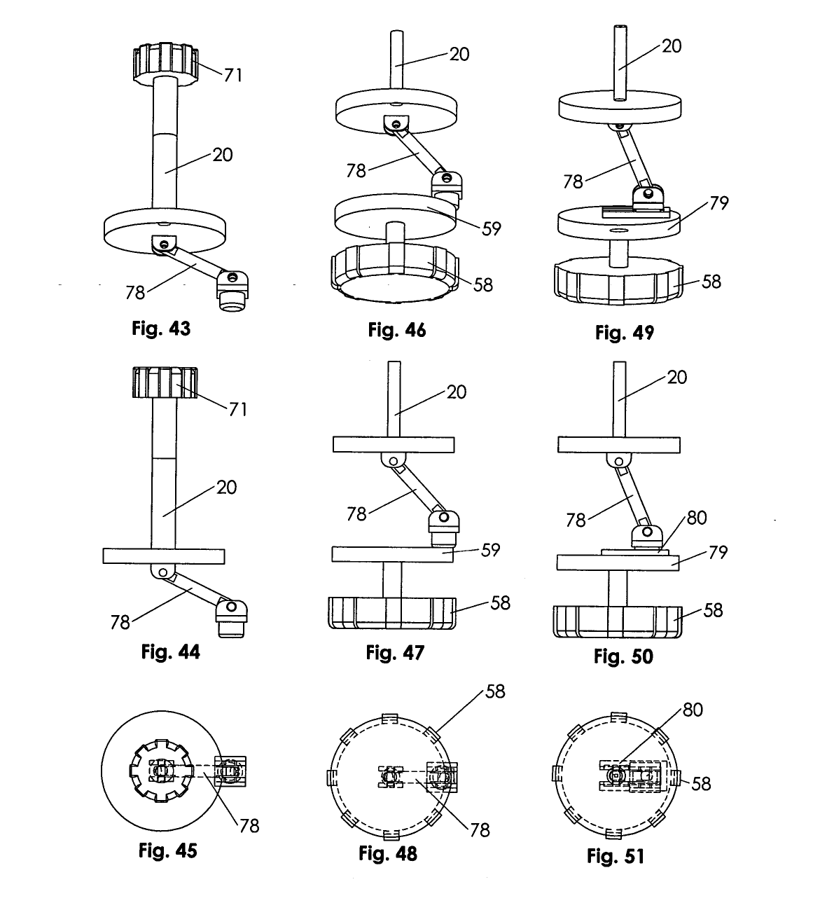

FIGS. 43, 44, and 45 show another embodiment of the present invention. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A movable pin 78 is pivotally connected to the bottom of the vertical axle 20 such that as the vertical axle 20 is moved up and down in its axial direction, the movable pin 78 will pivot and change the distance between it and the center of the vertical axle 20 thereby changing the oscillation angle. The pivoting arm 14 connects to the movable pin 78 and maintains the vertical position of the movable pin 78 such that as the vertical axle 20 is moved up and down, the movable pin 78 will move horizontally. As the vertical axle 20 is pulled up by the control knob 71, the distance between the movable pin 78 and the vertical axle 20 is reduced, thereby reducing the oscillation angle. As the vertical axle 20 is pushed down by the control knob 71, the distance between the movable pin 78 and the vertical axle 20 is increased, thereby increasing the oscillation angle. When the extremity of the movable pin 78 is positioned directly under the vertical axle 20, the oscillation angle is reduced to zero, thereby essentially stopping the oscillation of the fan.

FIGS. 46, 47, and 48 show another embodiment of the present invention. In this embodiment a movable pin 78 is pivotally connected to the bottom of the vertical axle 20 such that the movable pin 78 can pivot and change the distance between its extremity and the center of the vertical axle 20 thereby changing the oscillation angle. A control knob 58 with a control surface 59 is positioned under the movable pin 78. The control surface 59 can be moved up or down with the control knob 58. The movement may be by rotating the control knob 58 which may have a screw-type stem that rotates in a fixed hole with matching screw threads to advance or retract the control surface 59 against the movable pin 78. The control surface 59 may be a flat planar surface. As the control surface 59 is raised, the movable pin 78 is urged away from the center of the vertical axle 20. As the control surface 59 is lowered, the movable pin 78 is pivoted towards the center of the vertical axle 20. The oscillation angle will thereby be changed accordingly.

A variation of the embodiment shown in FIGS. 46, 47, and 48 is shown in FIGS. 49, 50, and 51. In this embodiment a movable pin 78 is pivotally connected to the bottom of the vertical axle 20 such that the movable pin 78 can pivot and change the distance between its extremity and the center of the vertical axle 20 thereby changing the oscillation angle. A control knob 58 with a control surface 79 is positioned under the movable pin 78. A track 80, preferably linear, is oriented radially on the control surface 79. The movable pin 78 is slidably engaged in the track 80 and may slide radially along the track 80. The control surface 79 can be moved up or down with the control knob 58. The movement may be by rotating the control knob 58 which may have a screw-type stem that rotates in a fixed hole with matching screw threads to advance or retract the control surface 79 against the movable pin 78. The control surface 79 may be a flat planar surface or a curved surface, such as a concave surface. As the control surface 79 is raised, the movable pin 78 is urged away from the center of the vertical axle 20. As the control surface 79 is lowered, the movable pin 78 is pivoted towards the center of the vertical axle 20. The oscillation angle will thereby be changed accordingly.

The structure of the 2 embodiments shown in FIGS. 46 through 48 and FIGS. 49 through 51 may also be reversed such that the control surface 59 is positioned at the bottom end of the vertical axle 20 with the control knob 71 at the top of the vertical axle 20, similar to the structure shown in FIGS. 43 through 45. A fixed planar surface is positioned under the movable pin 78. The planar surface may also have a track 80 similar to the control surface shown in FIGS. 49 through 51. As the vertical axle 20 is pulled up by the control knob 71, the distance between the movable pin 78 and the vertical axle 20 is reduced, thereby reducing the oscillation angle. As the vertical axle 20 is pushed down by the control knob 71, the distance between the movable pin 78 and the vertical axle 20 is increased, thereby increasing the oscillation angle.

Furthermore, the structure of the pivotal connection of the movable pin of the 2 embodiments shown in FIGS. 46 through 48 and FIGS. 49 through 51 and their reversed embodiments disclosed above may also be reversed. In this variation, the pivot is positioned on the bottom surface while the movable pin 78 is positioned at the planar surface at the bottom of the vertical axle 20. In this orientation, the adjustable mechanism operates in the same way as the embodiments shown in FIGS. 43 through 51.

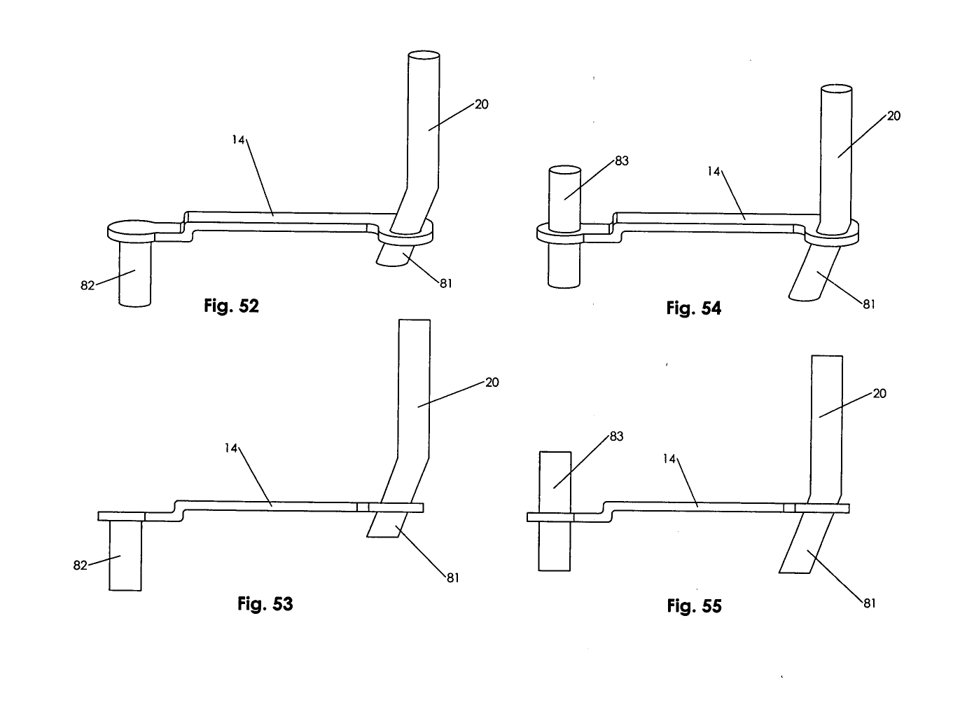

FIGS. 52 and 53 show yet another embodiment of the adjustable mechanism. In this embodiment, a short section 81 of the bottom end of the vertical axle 20 is bent at an angle. An end of the pivoting arm 14 has an opening that slides over this short angle section 81 of the vertical axle 20. The other end of the pivoting arm 14 is affixed to a movable member 82 that may be moved up or down to slide the pivoting arm 14 along the short angle section 81 of the vertical axle 20. Since the short angle section 81 of the vertical axle 20 is at an angle relative to the axis of the vertical axle 20, as the pivoting arm 14 is moved up or down on the short angle section 81, the distance from the end of the pivoting arm 14 to the center of the vertical axle 20 is changed, thereby changing the oscillating angle. Alternatively, the vertical axle 20 may be moved up or down while the other end of the pivoting arm 14 is affixed at a fixed location. A structure similar to the structure disclosed previously with a free rotating control knob 71 that is rotably connected to the top of the vertical axle 20 may be employed. The control knob 71 does not rotate with the vertical axle 20 but is connected to the vertical axle 20 such that it can move the vertical axle 20 up and down in its axial direction. This may be accomplished with an enlarged circular terminal 72 in the form of a sphere or a disc at the top extremity of the vertical axle 20 which is received in a corresponding cavity 73 at the bottom of the control knob 71. As the vertical axle 20 is moved up or down, the relative position of the pivoting arm 14 to the center of the vertical axle 20 is changed, thereby changing the oscillating angle.

An alternate embodiment of the adjustable mechanism is shown in FIGS. 54 and 55. In this embodiment, a short section 81 of the bottom end of the vertical axle 20 is bent at an angle. An end of the pivoting arm 14 has an opening that slides over this short angle section 81 of the vertical axle 20. The other end of the pivoting arm 14 has another opening that slides vertically over another vertical elongated member 83. The entire pivoting arm 14 may be moved up or down to slide the pivoting arm 14 along the short angle section 81 of the vertical axle 20. Since the short angle section 81 of the vertical axle 20 is at an angle relative to the axis of the vertical axle 20, as the pivoting arm 14 is moved up or down on the short angle section 81, the distance from the end of the pivoting arm 14 to the center of the vertical axle 20 is changed, thereby changing the oscillating angle. The pivoting arm 14 may be moved with a telescoping member that holds the pivoting arm 14 at a location between the two ends of the pivoting arm 14. The pivoting arm 14 may also be moved by an elongated member with one end affixed to a point between the two ends of the pivoting arm 14. When the elongated member is moved in the vertical direction, the pivoting arm 14 will also be moved along the short angle section 81 of the vertical axle 20.

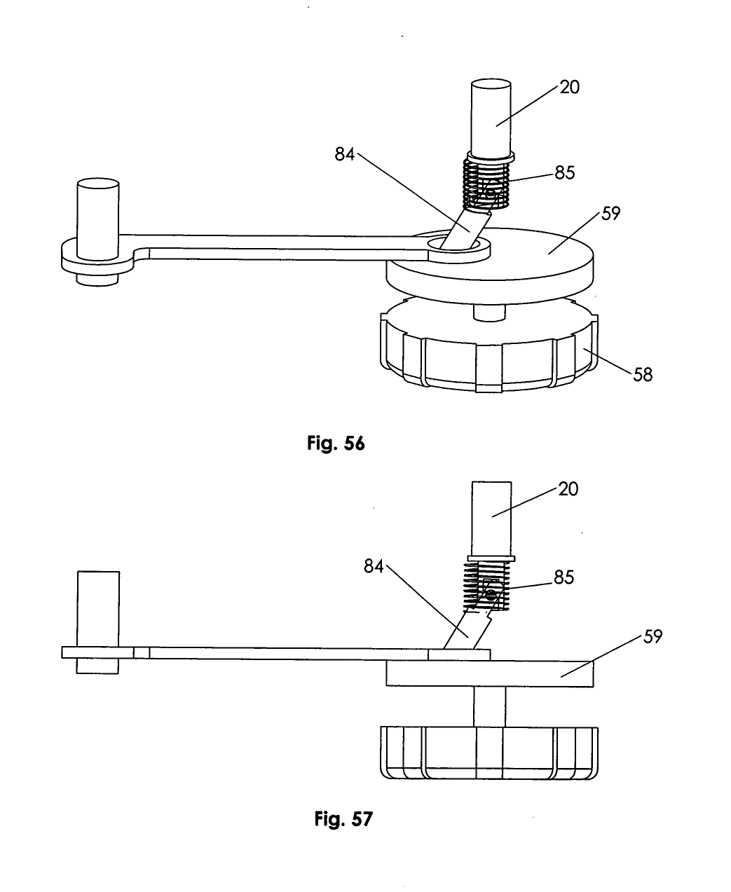

FIGS. 56 and 57 show another embodiment of the adjustable mechanism. In this embodiment, a short elongated member 84 is pivotally connected to the bottom of the vertical axle 20 such that the short elongated member 84 can pivot and change the distance between its extremity and the center of the vertical axle 20 thereby changing the oscillation angle. A spring 85 is positioned around the end of the vertical axle 20 resting against the short elongated member 84 and exerting a force against the short elongated member 84 urging it towards the vertical position. The spring 85 or another urging means may be positioned in any convenient location to providing the force to urge the short elongated member 84 towards the vertical position. A control knob 58 with a control surface 59 is positioned under the short elongated member 84. The control surface 59 can be moved up or down with the control knob 58. The movement may be by rotating the control knob 58 which may have a screw-type stem that rotates in a fixed hole with matching screw threads to advance or retract the control surface 59 against the movable pin 84. The control surface 59 may be a flat planar surface. As the control surface 59 is raised, the end of the short elongated member 84 is urged to pivot away from the center of the vertical axle 20. As the control surface 59 is lowered, the end of the short elongated member 84 is pivoted towards the center of the vertical axle 20. The oscillation angle will thereby be changed accordingly.

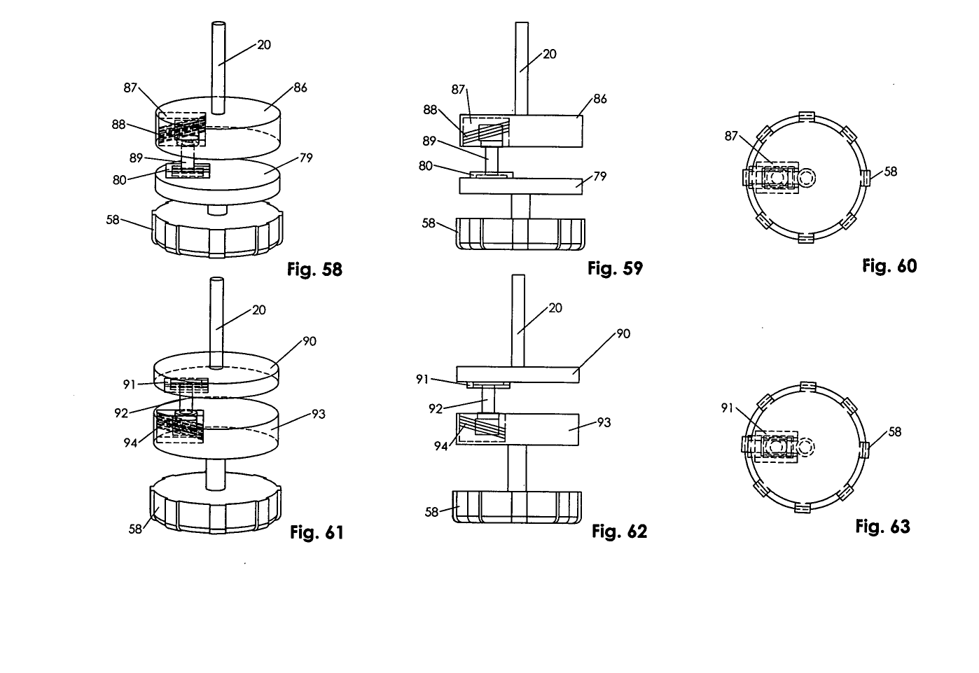

Another embodiment of the adjustable mechanism is shown in FIGS. 58, 59, and 60. This embodiment is a variation of the embodiment shown in FIGS. 34, 35, and 36. In this embodiment, a disc 86 is affixed to the bottom end of the vertical axle 20. The disc 86 has an elongated slot 87 with a slanted track 88 tapering downward from the center of the disc 86 toward the edge of the disc 86. The movable pin 89 has a top end that is slidably engaged to the track 88 in the elongated slot 87. A control knob 58 with a control surface 79 is positioned under the movable pin 89. The bottom end of the movable pin 89 is slidably engaged to a linear track 80 oriented radially in the control surface 79. The control surface 79 can be moved up or down with the control knob 58. The movement may be by rotating the control knob 58 which may have a screw-type stem that rotates in a fixed hole with matching screw threads to advance or retract the control surface 79 against the movable pin 89. As the control surface 79 is raised, the movable pin 89 is urged toward the center of the disc 86 due to the slanted track 88 in the elongated slot 87. As the control surface 79 is lowered, the movable pin 89 will move towards the edge of the disc 86. The oscillation angle will thereby be changed accordingly. Alternatively, the disc 86 may be replaced with an elongated member with an elongated slot with a slanted track. The other components remain unchanged and are structured in the same way.

A variation of the embodiment of the adjustable mechanism shown in FIGS. 58, 59, and 60 is shown in FIGS. 61, 62, and 63. In this embodiment, a disc 90 is affixed to the bottom end of the vertical axle 20. The disc 90 has a linear radial track 91. The movable pin 92 has a top end that is slidably engaged to the track 91. A control knob 58 with a control surface 93 is positioned under the movable pin 92. The bottom end of the movable pin 92 is slidably engaged to a slanted track 94 oriented radially in the control surface 93 and tapering upward from the center of the control surface 93 to the edge of the control surface 93. The control surface 93 can be moved up or down with the control knob 58. The movement may be by rotating the control knob 58 which may have a screw-type stem that rotates in a fixed hole with matching screw threads to advance or retract the control surface 93 against the movable pin 92. As the control surface 93 is raised, the movable pin 92 is urged toward the center of the disc 90 due to the slanted track 94. As the control surface 93 is lowered, the movable pin 92 will move towards the edge of the disc 90. The oscillation angle will thereby be changed accordingly. Alternatively, the disc 90 may be replaced with an elongated member with a linear radial track. The other components remain unchanged and are structured in the same way.

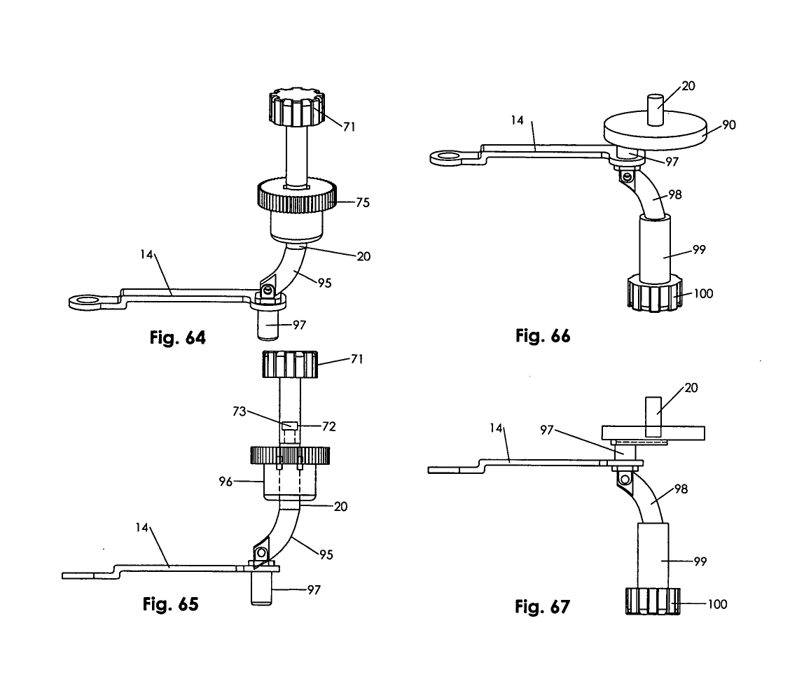

FIGS. 64 and 65 show another embodiment of the adjustable mechanism. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal 72 in the form of a sphere or a disc at the top extremity of the vertical axle 20 which is received in a corresponding cavity 73 at the bottom of the control knob 71. The bottom section 95 of the vertical axle 20 is made of a flexible material and has a curvature such that when the vertical axle 20 is moved up the bottom section 95 will straighten out as it is retracted into the gear housing 96. An elongated movable pin 97 is pivotally connected to the extremity of the bottom section 95 of the vertical axle 20 such that as the vertical axle 20 is moved up and down in its axial direction, the bottom section 95 will straighten or curve, respectively, and the distance between the movable pin 97 and the center of the vertical axle 20 is changed thereby changing the oscillation angle.

FIGS. 66 and 67 show another embodiment of the adjustable mechanism. This embodiment is essentially the upside-down embodiment of the adjustable mechanism shown in FIGS. 64 and 65. In this embodiment, a disc 90 is affixed to the bottom end of the vertical axle 20. The disc 90 may also be replaced with a simple elongated arm that extends from the bottom end of the vertical axle. A linear radial track 91 is positioned at the bottom of the disc 90 or the elongated arm, whichever embodiment is utilized. The movable pin 97 is pivotally connected to the terminal of a section of flexible curved end section 98 of a vertical adjustment member 99 such that as the vertical adjustment member 99 is moved up and down in its axial direction, the movable pin 97 will pivot and change the distance between it and the center of the vertical axle 20 thereby changing the oscillation angle. As the vertical adjustment member 99 is pulled down with the control knob 100, the distance between the movable pin 97 and the vertical axle 20 is reduced, thereby reducing the oscillation angle. As the vertical adjustment member 99 is pushed up with the control knob 100, the distance between the movable pin 97 and the vertical axle 20 is increased, thereby increasing the oscillation angle. When the movable pin 97 is positioned directly under the vertical axle 20, the oscillation angle is reduced to zero, thereby essentially stopping the oscillation of the fan.

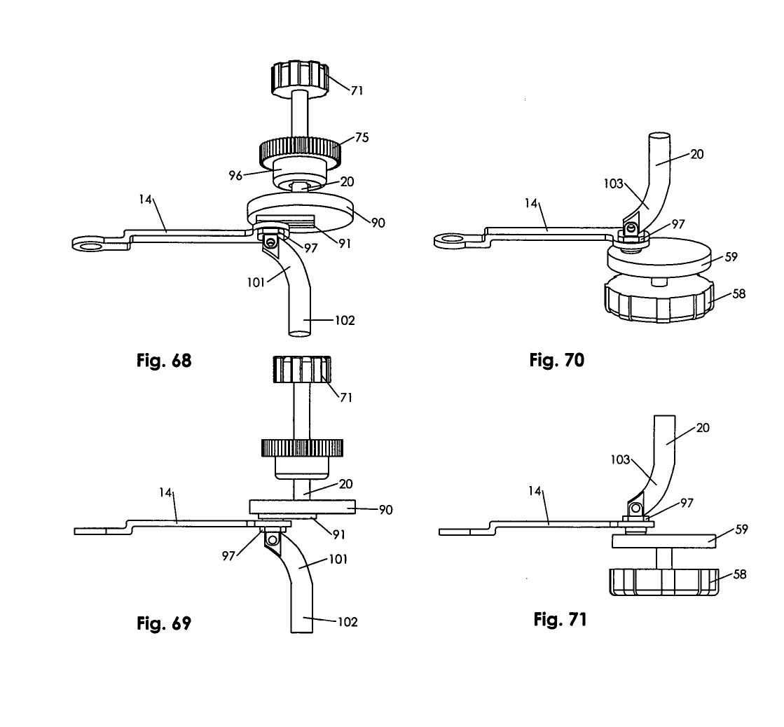

FIGS. 68 and 69 show another embodiment of the adjustable mechanism. This embodiment is a combined and modified embodiment of the adjustable mechanism shown in FIGS. 64, 65, 66, and 67. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A disc 90 is affixed to the bottom end of the vertical axle 20. The disc 90 may also be replaced with a simple elongated arm that extends from the bottom end of the vertical axle 20. A linear radial track 91 is positioned at the bottom of the disc 90 or the elongated arm, whichever embodiment is utilized. The movable pin 97 is pivotally connected to the terminal of a section of flexible curved end section 101 of a fixed vertical member 102 such that as the vertical axle 20 is moved up and down in its axial direction, the movable pin 97 will pivot and change the distance between it and the center of the vertical axle 20 thereby changing the oscillation angle. As the vertical axle 20 is pushed down with the control knob 71, the distance between the movable pin 97 and the vertical axle 20 is increased, thereby increasing the oscillation angle. As the vertical axle 20 is pulled up with the control knob 71, the distance between the movable pin 97 and the vertical axle 20 is reduced, thereby decreasing the oscillation angle. When the movable pin 97 is positioned directly under the vertical axle 20, the oscillation angle is reduced to zero, thereby essentially stopping the oscillation of the fan.

FIGS. 70 and 71 show another embodiment of the adjustable mechanism. This embodiment is a modified embodiment of the adjustable mechanism shown in FIGS. 68 and 69. In this embodiment, a control knob 58 with a control surface 59 is positioned under the movable pin 97. The control surface 59 can be moved up or down with the control knob 58. The movement may be by rotating the control knob 58 which may have a screw-type stem that rotates in a fixed hole with matching screw threads to advance or retract the control surface 59 against the movable pin 97. The control surface 59 may be a flat planar surface. The movable pin 97 is pivotally connected to the terminal of a section of flexible curved end section 103 of the vertical axle 20 such that as the control surface 59 is moved up and down in its axial direction, the movable pin 97 will pivot and change the distance between it and the center of the vertical axle 20 thereby changing the oscillation angle. As the control surface 59 is moved down with the control knob 58, the distance between the movable pin 97 and the vertical axle 20 is reduced, thereby reducing the oscillation angle. As the control surface 59 is moved up with the control knob 58, the distance between the movable pin 97 and the vertical axle 20 is increased, thereby increasing the oscillation angle. When the movable pin 97 is positioned directly under the vertical axle 20, the oscillation angle is reduced to zero, thereby essentially stopping the oscillation of the fan.

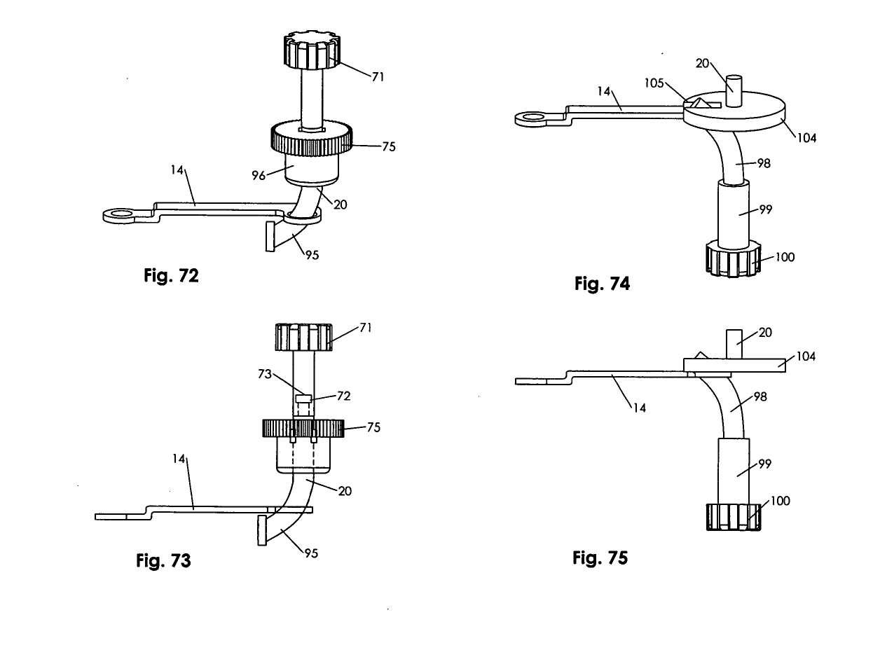

FIGS. 72 and 73 show another embodiment of the adjustable mechanism. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal 72 in the form of a sphere or a disc at the top extremity of the vertical axle 20 which is received in a corresponding cavity 73 at the bottom of the control knob 71. The bottom section 95 of the vertical axle 20 is made of a flexible material and has a curvature such that when the vertical axle 20 is moved up the bottom section 95 will straighten out as it is retracted into the gear housing 96. The pivoting arm 14 is slidably connected to the bottom section 95 of the vertical axle 20 such that as the vertical axle 20 is moved up and down in its axial direction, the bottom section 95 will straighten or curve, respectively, and the distance between the end of the pivoting arm 14 and the center of the vertical axle 20 is changed thereby changing the oscillation angle.

FIGS. 74 and 75 show another embodiment of the adjustable mechanism. This embodiment is essentially a variation of the adjustable mechanism shown in FIGS. 66 and 67. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. The pivoting arm 14 is slidably connected to a flexible curved end section 98 of a vertical adjustment member 99 such that as the vertical adjustment member 99 is moved up and down in its axial direction, the pivoting arm 14 will slide up and down the flexible curved end section 98 and change the distance between it and the center of the vertical axle 20 thereby changing the oscillation angle. As the vertical adjustment member 99 is pulled down with the control knob 100, the distance between the end of the pivoting arm 14 and the vertical axle 20 is reduced, thereby reducing the oscillation angle. As the vertical adjustment member 99 is pushed up with the control knob 100, the distance between the end of the pivoting arm 14 and the vertical axle 20 is increased, thereby increasing the oscillation angle.

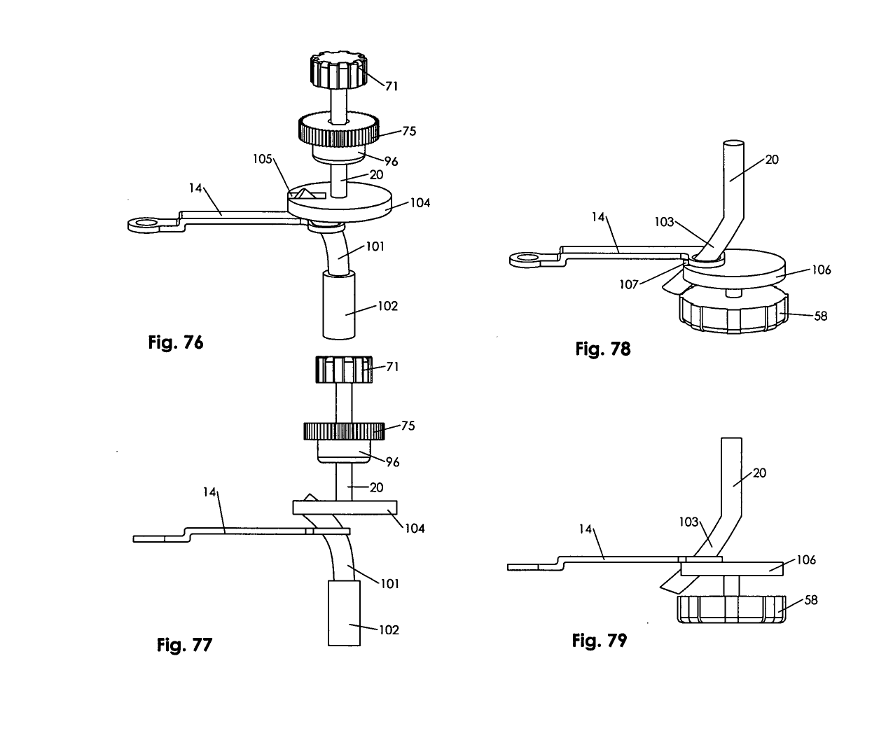

FIGS. 76 and 77 show another embodiment of the adjustable mechanism. This embodiment is a modified embodiment of the adjustable mechanism shown in FIGS. 68 and 69. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A disc 104 is affixed to the bottom end of the vertical axle 20. The disc 104 may also be replaced with a simple elongated arm that extends from the bottom end of the vertical axle 20. A slot 105 is formed in the disc 104 or the elongated arm, whichever embodiment is utilized. The pivoting arm 14 is slidably connected to a section of flexible curved end section 101 of a fixed vertical member 102 such that as the vertical axle 20 is moved up and down in its axial direction, the pivoting arm 14 will slide along the flexible curved end section 101 and change the distance between it and the center of the vertical axle 20 thereby changing the oscillation angle. As the vertical axle 20 is pushed down with the control knob 71, the distance between the end of the pivoting arm 14 and the vertical axle 20 is decreased, thereby decreasing the oscillation angle. As the vertical axle 20 is pulled up with the control knob 71, the distance between the end of the pivoting arm 14 and the vertical axle 20 is increased, thereby increasing the oscillation angle.

FIGS. 78 and 79 show another embodiment of the adjustable mechanism. This embodiment is a modified embodiment of the adjustable mechanism shown in FIGS. 70 and 71. In this embodiment, a control knob 58 with a control surface 106 is positioned under the vertical axle 20. The control surface 106 can be moved up or down with the control knob 58. The movement may be by rotating the control knob 58 which may have a screw-type stem that rotates in a fixed hole with matching screw threads to advance or retract the control surface 106. The control surface 106 may be a flat planar surface. A slot 107 is formed in the control surface 106. The pivoting arm 14 is slidably connected to a section 103 of the vertical axle 20 that is formed at an angle to the vertical axis such that as the control surface 106 is moved up and down in its axial direction, the pivoting arm 14 will slide along the angle section 103 of the vertical axle 20 and change the distance between it and the center of the vertical axle 20 thereby changing the oscillation angle. The angled section 103 of the vertical axis 20 extends through the slot 107 in the control surface 106. As the control surface 106 is moved down with the control knob 58, the distance between the end of the pivoting arm 14 and the vertical axle 20 is increased, thereby increasing the oscillation angle. As the control surface 106 is moved up with the control knob 58, the distance between the end of the pivoting arm 14 and the vertical axle 20 is decreased, thereby reducing the oscillation angle.

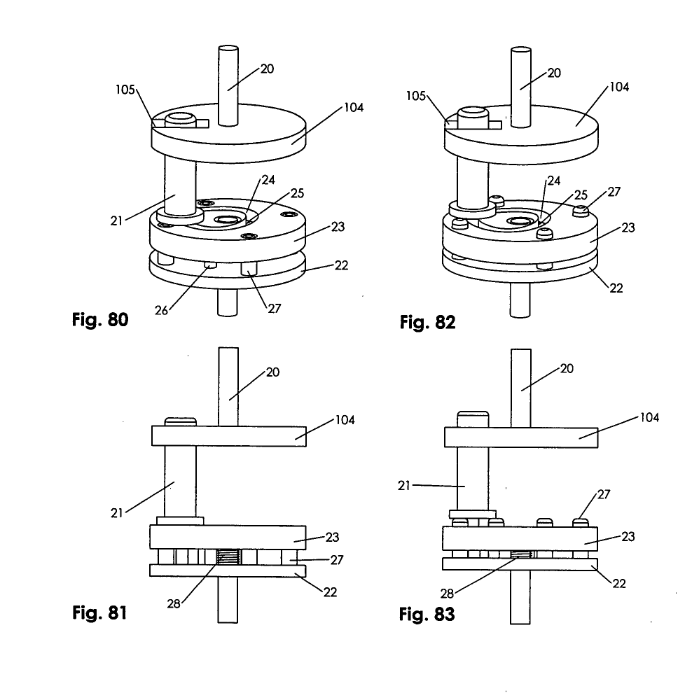

Another embodiment of the adjustable mechanism is shown in FIGS. 80, 81, 82, and 83. This is an upside-down variation of the adjustable mechanism shown in FIGS. 3, 4, 5, and 6. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. The movable pin 21 is slidably engaged in the slot 105 whereby the rotation of the disc 104 or elongated arm will urge the movable pin 21 to move in a circular path around the vertical axle 20. The adjustable mechanism comprises of two discs, a top disc 23 and a bottom disc 22. The top disc 23 has an offset circulating track 24 on its top surface. Within this circulating track 24 are multiple through holes 25 for the movable pin 21 to insert into. The top disc 23 is disposed directly on top of the bottom disc 22. Multiple corresponding posts 26 extend from the bottom disc 22 through the multiple through holes 25 in the circular track 24 in the top disc 23. In the rest position, where the adjustable mechanism is not being activated, the multiple posts 26 are positioned just below the multiple through holes 25 in the circular track 24. In the activated position, the multiple posts 26 will extend into the multiple through holes 25 in the circular track 24 until the tips of the posts 26 are flush with the bottom of the circular track 24. The multiple posts 26 may also protrude slightly from the bottom surface of the circular track 24. Each through hole 25 is positioned at a different distance from the center of the bottom disc 22. Multiple positioning posts 27 extend from the bottom disc 22 through the top disc 23 to align the orientation of the two discs 22, 23 and prevent rotation of one disc with respect to the other disc. A spring 28 is mounted between the two discs 22, 23, urging the separation of the two discs 22, 23. An actuating mechanism, such as actuating arm, pushes up against the bottom disc 22 to adjust the oscillating angle. When the actuating arm pushes the bottom disc 22 up, the multiple posts 26 would extend through the multiple through holes 25 in the circular track 24 in the top disc 23 thereby pushing the movable pin 21 out of the hole it is resting in. Upon release of the actuating arm, the spring 28 will urge the two discs 22, 23 to separate and, thereby, pull the multiple posts 26 of the bottom disc 22 out of the multiple through holes 25 in the top disc 23. As the circular discs 22, 23 continue to rotate, the movable pin 21 would move inside the circulating track 24 to the next through hole in the circular track 24. Since the radius of rotation has thus been changed, the angle of oscillation of the motor housing 3 has correspondingly been changed. The pivoting arm 14 is positioned such that it constantly exerts a downward force on the movable pin 21 to maintain the movable pin 21 within the circular track 24. This downward force may be simply from the flexing of the pivoting arm 14 or from a spring at the bottom or top of the other end of the pivoting arm 14, pushing or pulling the pivoting arm 14 downward.

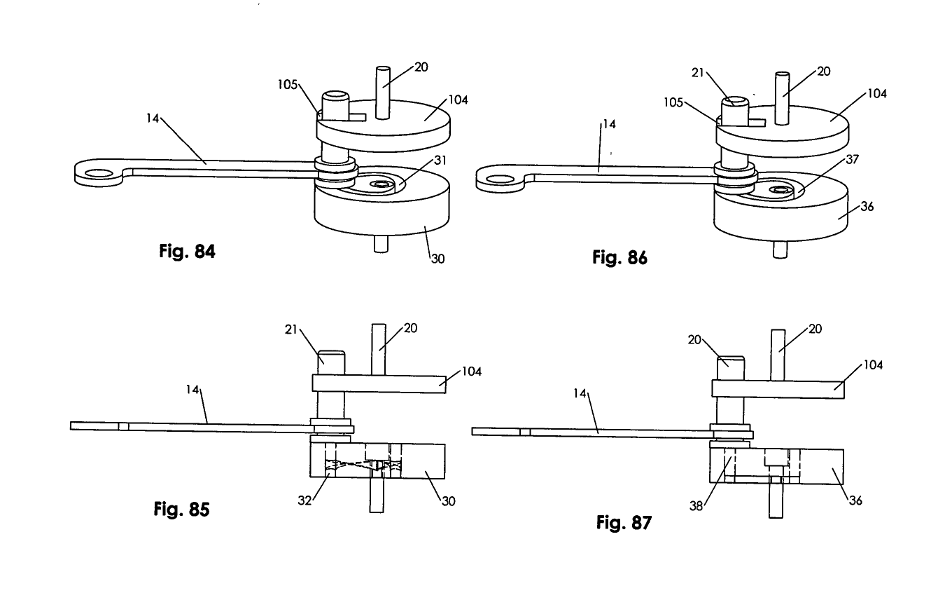

Another embodiment of the present invention is shown in FIGS. 84 and 85. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. A second disc 30 is positioned directly under the disc 104 at the end of the vertical axle 20. This second disc 30 has an offset circular track 31 on its top surface and multiple through holes 32 extending through the disc 30 from the bottom of the circular track 31. The section of the circular track 31 that leads from one through hole 32 to the next through hole 32 is tapered such that after the movable pin 21 is withdrawn from one through hole 32 it would slide to the next through hole 32, aided by the incline in the tapered track section, without delay. The through holes 32 are positioned at varying radiuses from the center of the vertical axle 20, therefore, various oscillating angles can be set by moving the movable pin 21 to the different through holes 32. This design will shorten the response time of the change in the angle of oscillation when the position of the movable pin 21 is changed. The movable pin 21 may be withdrawn from the hole it is in by either lowering the second disc 30 or by fixing the movable pin 21 within the slot 105 in the disc 104 at the end of the vertical axle 20 whereby the movable pin 21 is pulled out of the through holes 32 when the vertical axle 20 is pulled up. The structure of the vertical axle 20 may be similar to that shown in FIGS. 40, 41, and 42 for the movable vertical axle. Alternatively, the movable pin 21 may be withdrawn from the hole it is in by limiting the vertical movement of the pivoting arm 14 with respect to the movable pin 21 and moving the pivoting arm 14 upward, thereby lifting the movable pin 21 from the hole 32.

FIGS. 86 and 87 show an alternate embodiment of the adjustable mechanism shown in FIGS. 84 and 85. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. A second disc 36 is positioned directly under the disc 104 at the end of the vertical axle 20. This second disc 36 has an offset circular track 37 on its top surface and multiple through holes 38 extending through the disc 36 from the bottom of the circular track 37. The section of the circular track that leads from one through hole to the next through hole is level such that after the movable pin 21 is withdrawn from one through hole 38 it would slide to the next through hole 38 after a short period of time. The through holes 38 are positioned at varying radiuses from the center of the vertical axle 20, therefore, various oscillating angles can be set by moving the movable pin 21 to the different through holes 38. The movable pin 21 may be withdrawn from the hole it is in by either lowering the second disc 36 or by fixing the movable pin 21 within the slot 105 in the disc 104 at the end of the vertical axle 20 whereby the movable pin 21 is pulled out of the through hole 38 when the vertical axle 20 is pulled up. The structure of the vertical axle 20 may be similar to that shown in FIGS. 40, 41, and 42 for the movable vertical axle. Alternatively, the movable pin 21 may be withdrawn from the hole 38 it is in by limiting the vertical movement of the pivoting arm 14 with respect to the movable pin 21 and moving the pivoting arm 14 upward, thereby lifting the movable pin 21 from the hole 38.

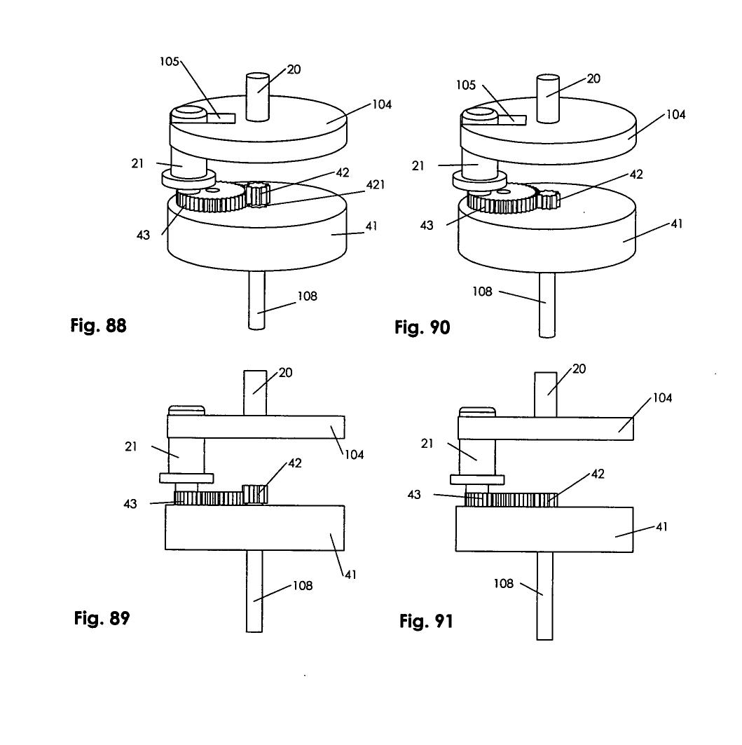

FIGS. 88, 89, 90, and 91 show an alternate embodiment of the adjustable mechanism shown in FIGS. 19, 20, 21, and 22. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. A second disc 41 or an elongated member with a through hole in its center is positioned below the disc 104 at the bottom end of the vertical axle 20. An axle 108 that extends from the bottom through the second disc 41 has a small gear 42 at its end that engages a gear-shaped cavity 421 in the top of the disc 41 or the elongated member. The gear-shaped cavity 421 only extends partially through the disc 41 or the elongated member and does not extend through the disc 41 or the elongated member but is of sufficient depth such that it will engage the small gear 42 without slipping. A larger gear 43 with the same pitch gear teeth as the small gear 42 is rotably affixed to the top surface of the disc 41 or elongated member and engages the small gear 42. The movable pin 21 is affixed to the top surface of this larger gear 43 at an offset location away from the center of the larger gear 43. To adjust the position of the movable pin 21 the vertical axle 108 through the second disc 41 is pushed up to disengage the small gear 42 from the gear-shaped cavity 421 in the top of the disc 41 or elongated member. Once the small gear 42 is disengaged from the gear-shaped cavity 421, the vertical axle 108 can be rotated which in turn rotates the small gear 42. The small gear 42 would rotate the larger gear 43. As the larger gear 43 is rotated, the distance of the movable pin 21 from the center of the vertical axle 20 is changed thereby changing the oscillating angle of the motor housing 3. The top of the movable pin 21 is engaged in the slot 105 in the disc 104 or elongated member at the bottom end of the vertical axle 20 whereby the rotation of the vertical axle 20 will urge the movable pin 21 to rotate around the vertical axle 20.

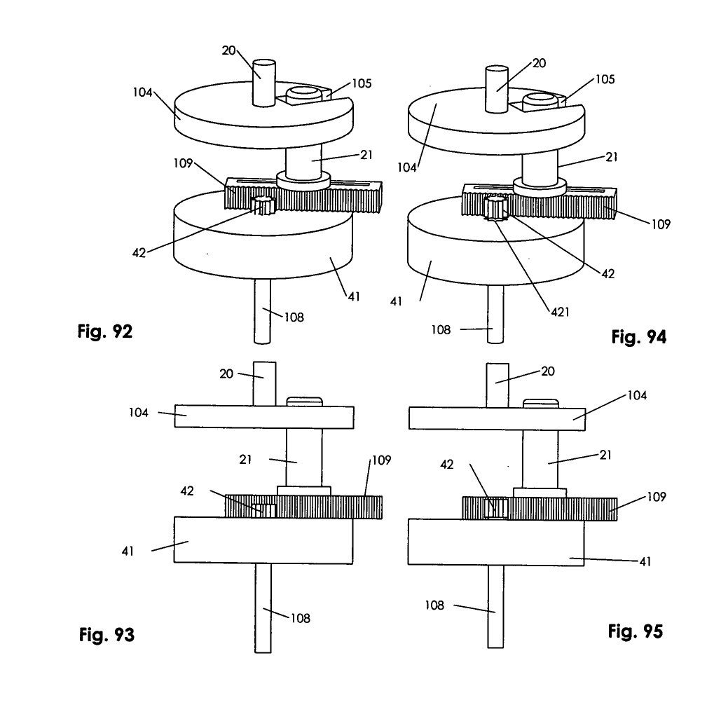

FIGS. 92, 93, 94, and 95 show another variation of the embodiment of the adjustable mechanism shown in FIGS. 26, 27, 28, 29, and 30. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. A second disc 41 or an elongated member with a through hole in its center is positioned below the disc 104 at the bottom end of the vertical axle 20. An axle 108 that extends from the bottom through the second disc 41 has a small gear 42 at its end that engages a gear-shaped cavity 421 in the top of the disc 41 or the elongated member. The gear-shaped cavity 421 only extends partially through the disc 41 or the elongated member and does not extend through the disc 41 or the elongated member but is of sufficient depth such that it will engage the small gear 42 without slipping. A gear rack 109 with the same pitch gear teeth as the small gear 42 is slidably affixed to the top surface of the disc 41 or elongated member and engages the small gear 42. The movable pin 21 is affixed to the top surface of this gear rack 109. To adjust the position of the movable pin 21 the vertical axle 108 through the second disc 41 is urged up to disengage the small gear 42 from the gear-shaped cavity 421 in the top of the disc 41. Once the small gear 42 is disengaged from the gear-shaped cavity 421, the vertical axle 108 can be rotated which in turn rotates the small gear 42. The small gear 42 would move the gear rack 109 and change the distance between the movable pin 21 and the center of the vertical axle 20 thereby changing the oscillating angle of the motor housing 3. The top of the movable pin 21 is engaged in the slot 105 in the disc 104 or elongated member at the bottom end of the vertical axle 20 whereby the rotation of the vertical axle 20 will urge the movable pin 21 to rotate around the vertical axle 20.

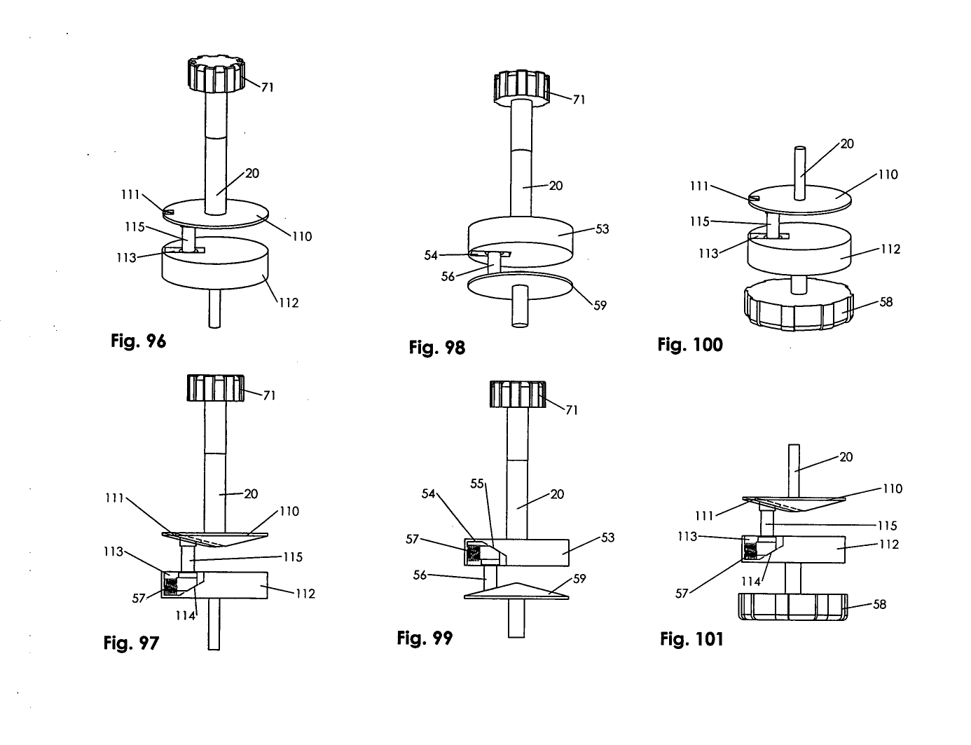

FIGS. 96 and 97 show another variation of the embodiment of the adjustable mechanism shown in FIGS. 31, 32, and 33. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A control surface 110 with a slot 111 that does not extend through the thickness of the control surface 110 is affixed to the bottom end of the vertical axle 20. A disc 112 or an elongated member is positioned under the control surface 110. The disc 112 or the elongated member has an elongated slot 113 with a slanted bottom surface 114 tapering downward toward the edge of the disc 112 or elongated member. The top end of the movable pin 115 is engaged in the slot 111 in the control surface 110. The movable pin 115 has a bottom end that is slidably positioned within the elongated slot 113 and slides on the slanted bottom surface 114 in the elongated slot 113. A spring 57 is positioned between the bottom end of the movable pin 115 and one end of the elongated slot 113 to provide an urging force towards the center of the disc 112. The control surface 110 may be a flat planar surface or may be tapered in a conical shape rising from its edge to the center. As the control surface 110 is raised, the movable pin 115 is urged away from the edge of the disc 112 due to the force of the spring 57 and the slanted bottom surface 114. As the control surface 110 is lowered, the movable pin 115 will be forced toward the edge of the disc 112 or elongated member due to the slanted bottom surface 114 in the elongated slot 113. The oscillation angle will thereby be changed accordingly.

FIGS. 98 and 99 show another variation of the embodiment of the adjustable mechanism shown in FIGS. 31, 32, and 33. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. In this embodiment, a disc 53 is affixed to the bottom end of the vertical axle 20. The disc 53 has an elongated slot 54 with a slanted top surface 55 tapering downward toward the center of the disc 53. The movable pin 56 has a top end that is slidably positioned within the elongated slot 54 and slides on the slanted top surface 55 in the elongated slot 54. A spring 57 is positioned between the top end of the movable pin 56 and one end of the elongated slot 54 to provide an urging force towards the center of the disc 53. A control surface 59 is positioned under the movable pin 56. The control surface 59 is non-movable and may be fixed to the housing 3 of the fan. The control surface 59 may be a flat planar surface or may be tapered in a conical shape rising from its edge to the center. As the disc 53 at the bottom end of the vertical axle 20 is raised, the movable pin 56 is urged by the spring 57 toward the center of the disc 53. As the disc 53 is lowered, the movable pin 56 will be urged to move towards the edge of the disc 53 due to the sloping top surface 55 in the slot 54. The oscillation angle will thereby be changed accordingly. Alternatively, the disc 53 may be replaced with an elongated member with an elongated slot 54. The other components remain unchanged and are structured in the same way.

FIGS. 100 and 101 show another embodiment of the present invention. In this embodiment, a disc 110 or an elongated member with a slot 111 that does not extend through the thickness of the disc 110 or elongated member surface is affixed to the bottom end of the vertical axle 20. A second disc 112 or an elongated member is positioned under the disc 110. The second disc 112 or the elongated member has an elongated slot 113 with a slanted bottom surface 114 tapering downward toward the edge of the second disc 112 or elongated member. The top end of the movable pin 115 is engaged in the slot 111 in the top disc 110. The movable pin 115 has a bottom end that is slidably positioned within the elongated slot 113 and slides on the slanted bottom surface 114 in the elongated slot 113. A spring 57 is positioned between the bottom end of the movable pin 115 and one end of the elongated slot 113 to provide an urging force towards the center of the second disc 112. The top disc 110 may be a flat planar surface or may be tapered in a conical shape rising from its edge to the center. As the second disc 112 is raised, the movable pin 115 is urged away from the edge of the second disc 112 due to the force of the spring 57 and the slanted bottom surface 114. As the second disc 112 is lowered, the movable pin 115 will be forced toward the edge of the disc 112 or elongated member due to the slanted bottom surface 114 in the elongated slot 113. The oscillation angle will thereby be changed accordingly.

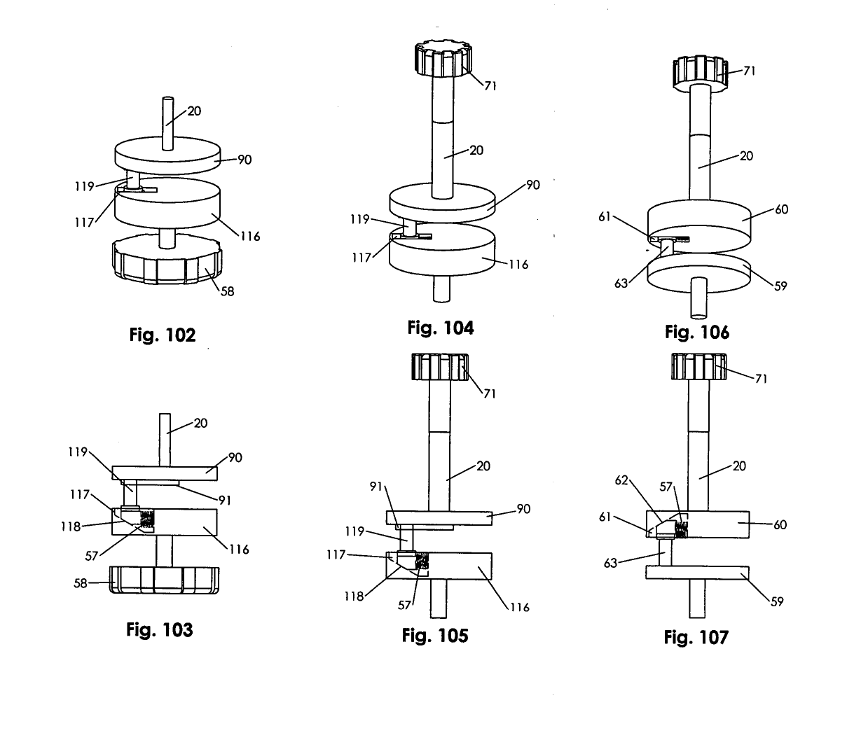

FIGS. 102 and 103 show another embodiment of the present invention. In this embodiment, a disc 90 or an elongated member with a slot 91 that does not extend through the thickness of the disc 90 or elongated member is affixed to the bottom end of the vertical axle 20. A second disc 116 or an elongated member is positioned under the bottom end of the vertical axle 20. The second disc 116 or the elongated member has an elongated slot 117 with a slanted bottom surface 118 tapering downward toward the vertical axle 20. The top end of the movable pin 119 is engaged in the slot 91 in the disc 90 or elongated member affixed at the bottom of the vertical axle 20. The movable pin 119 has a bottom end that is slidably positioned within the elongated slot 117 and slides on the slanted bottom surface 118 in the elongated slot 117. A spring 57 is positioned between the bottom end of the movable pin 119 and one end of the elongated slot 117 to provide an urging force towards the edge of the disc 116. As the second disc 116 or elongated member is raised, the movable pin 119 is urged away from the edge of the disc 116 due to the slanted bottom surface 118 in the slot 117. As the second disc 116 or elongated member is lowered, the movable pin 119 will be forced toward the edge of the disc 116 or elongated member due to the slanted bottom surface 118 in the elongated slot 117. The oscillation angle will thereby be changed accordingly.

FIGS. 104 and 105 show another variation of the embodiment of the adjustable mechanism shown in FIGS. 31, 32, and 33. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A control surface 90 with a slot 91 that does not extend through the thickness of the control surface 90 is affixed to the bottom end of the vertical axle 20. A disc 116 or an elongated member is positioned under the control surface 90. The disc 116 or the elongated member has an elongated slot 117 with a slanted bottom surface 118 tapering downward toward the center of the disc 116 or elongated member. The top end of the movable pin 119 is engaged in the slot 91 in the control surface 90. The movable pin 119 has a bottom end that is slidably positioned within the elongated slot 117 and slides on the slanted bottom surface 118 in the elongated slot 117. A spring 57 is positioned between the bottom end of the movable pin 119 and one end of the elongated slot 117 to provide an urging force towards the edge of the disc 116. The control surface 90 may be a flat planar surface or may be tapered in a conical shape rising from its edge to the center. As the control surface 90 is raised, the movable pin 119 is urged away from the center of the disc 116 due to the force of the spring 57 and the slanted bottom surface 118. As the control surface 90 is lowered, the movable pin 119 will be forced toward the center of the disc 116 or elongated member due to the slanted bottom surface 118 in the elongated slot. The oscillation angle will thereby be changed accordingly.

FIGS. 106 and 107 show another variation of the embodiment of the adjustable mechanism shown in FIGS. 31, 32, and 33. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. In this embodiment, a disc 60 is affixed to the bottom end of the vertical axle 20. The disc 60 has an elongated slot 61 with a slanted top surface 62 tapering downward toward the edge of the disc 60. The movable pin 63 has a top end that is slidably positioned within the elongated slot 61 and slides on the slanted top surface 62 in the elongated slot 61. A spring 57 is positioned between the top end of the movable pin 63 and one end of the elongated slot 61 to provide an urging force towards the edge of the disc 60. A control surface 59 is positioned under the movable pin 63. The control surface 59 is non-movable and may be fixed to the housing 3 of the fan. The control surface 59 may be a flat planar surface or may be tapered in a conical shape rising from its edge to the center. As the disc 60 at the bottom end of the vertical axle 20 is raised, the movable pin 63 is urged by the spring 57 toward the edge of the disc 60. As the disc 60 is lowered, the movable pin 63 will be urged to move towards the center of the disc 60 due to the sloping top surface 62 in the slot 61. The oscillation angle will thereby be changed accordingly. Alternatively, the disc 60 may be replaced with an elongated member with an elongated slot 61. The other components remain unchanged and are structured in the same way.

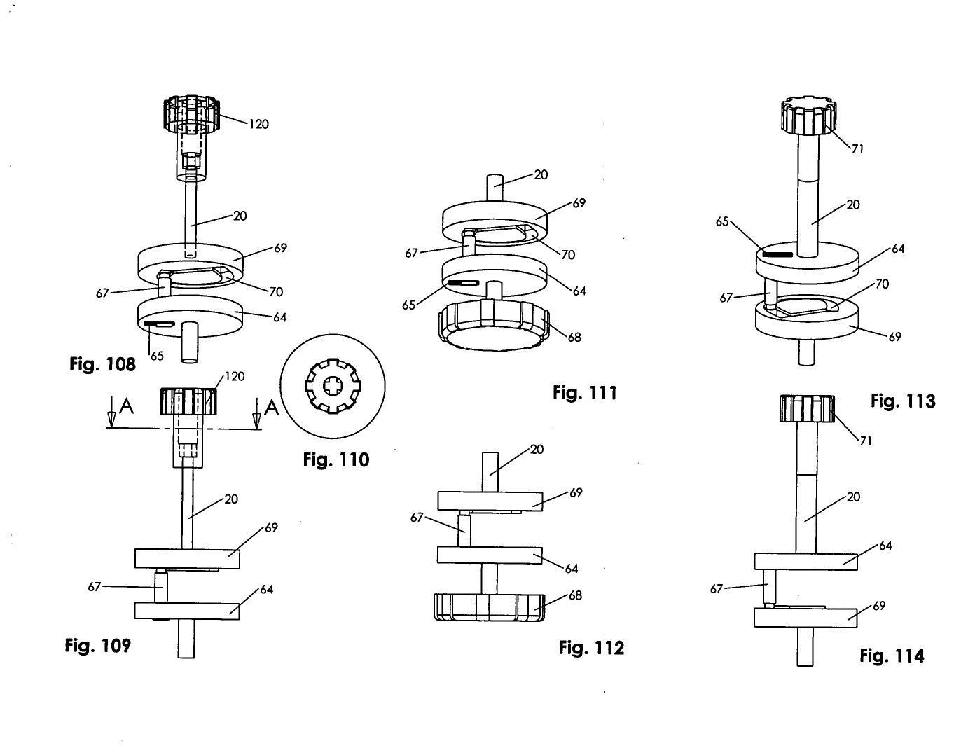

FIGS. 108, 109, and 110 show another variation of the embodiment of the adjustable mechanism shown in FIGS. 37, 38, and 39. In this embodiment, a normally free rotating control knob 120 is rotably connected to the top of the vertical axle 20. The control knob 120 normally does not rotate with the vertical axle 20 but is connected to the vertical axle 20 such that when it is moved upward or alternatively downward, it can engage the vertical axle 20 to enable the control knob 120 to rotate the vertical axle 20. This may be accomplished with a variety of well known designs. One such design is to have a symmetrical geometric shape such as gear teeth at the top extremity of the vertical axle 20 which may be engaged by corresponding symmetrical geometric shaped cavity such as a gear cavity at the bottom of the control knob 120, or vice versa, as shown in FIG. 110. A spring may optionally be utilized to ensure that the gear teeth and the gear cavity remain separated until force is applied to the control knob 120 to engage them. In this embodiment, a disc 69 is affixed to the bottom end of the vertical axle 20. The disc 69 has a spiral track 70 with a shoulder near its open bottom and can be rotated with the control knob 120. The top end of the movable pin 67 has a larger end that fits inside the spiral track 70 but is larger than the shoulder such that it cannot be pulled out of the track 70 from the bottom and is slidably positioned within the spiral track 70. A second free rotating disc 64 or elongated member with an elongated slot 65 oriented radially from the center of the disc 64 to near the edge of the disc 64 is positioned directly under the disc 69 at the bottom end of the vertical axle 20 and is restrained from vertical movement such as by fixing it to the housing 3 of the fan. The bottom surface of the slot 65 has teeth formed to match corresponding teeth on the bottom end of the movable pin 67. The movable pin 67 has a bottom end with teeth that engage the teeth in the bottom surface of the slot 65 in the disc 64 and is slidable within the elongated slot 65 when the teeth are disengaged. To move the movable pin 67, the control knob 120 is first pulled up to disengage the teeth at the bottom end of the movable pin 67 and then the control knob 120 is rotated. The movable pin 67 is urged to slide along the spiraling track 70 thereby changing its distance from the center of the disc 64. The oscillation angle will thereby be changed accordingly. Alternatively, the disc 64 may be replaced with an elongated member with a similar elongated slot 65 as the disc 64. The other components remain unchanged and are structured in the same way.

In an alternate embodiment, instead of positioning the teeth on the bottom surface of the slot 65, the teeth are positioned under the top ledge of the slot 65 to match corresponding teeth on the shoulder at the bottom end of the movable pin 67. The movable pin 67 has an enlarged bottom end with teeth at the shoulder of the enlarged end to engage the teeth under the top ledge of the slot 65 in the disc 64 and is slidable within the elongated slot 65 when the teeth are disengaged. To move the movable pin 67, the disc 69 is first pushed down to disengage the teeth between the top ledge of the slot 65 and the shoulder of the enlarged end of the movable pin 67 and then the control knob 120 is rotated. The movable pin 67 is urged to slide along the spiraling track 70 thereby changing its distance from the center of the disc 64. The oscillation angle will thereby be changed accordingly.

FIGS. 111 and 112 show another variation of the embodiment of the adjustable mechanism shown in FIGS. 108, 109, and 110. In this embodiment, a disc 69 is affixed to the bottom end of the vertical axle 20. The disc 69 has a spiral track 70 with a shoulder near its open bottom. The top end of the movable pin 67 has a larger end that fits inside the spiral track 70 but is larger than the shoulder such that it cannot be pulled out of the track 70 from the bottom and is slidably positioned within the spiral track 70. A second free rotating disc 64 or elongated member with an elongated slot 65 oriented radially from the center of the disc 64 to near the edge of the disc 64 is positioned directly under the disc 69 at the bottom end of the vertical axle 20 and is provided with a control knob 68. The bottom surface of the slot 65 has teeth formed to match corresponding teeth on the bottom end of the movable pin 67. The movable pin 67 has a bottom end with teeth that engage the teeth in the bottom surface of the slot 65 in the disc 64 and is slidable within the elongated slot 65 when the teeth are disengaged. To move the movable pin 67, the control knob 68 is first pulled down to disengage the teeth at the bottom end of the movable pin 67 and then the control knob 68 is rotated. The movable pin 67 is urged to slide along the spiraling track 70 thereby changing its distance from the center of the disc 64. The oscillation angle will thereby be changed accordingly. Alternatively, the disc 64 may be replaced with an elongated member with a similar elongated slot 65 as the disc 64. The other components remain unchanged and are structured in the same way.

In an alternate embodiment, instead of positioning the teeth on the bottom surface of the slot 65, the teeth are positioned under the top ledge of the slot 65 to match corresponding teeth on the shoulder at the bottom end of the movable pin 67. The movable pin 67 has an enlarged bottom end with teeth at the shoulder of the enlarged end to engage the teeth under the top ledge of the slot 65 in the disc 64 and is slidable within the elongated slot 65 when the teeth are disengaged. To move the movable pin 67, the control surface 68 is first pushed up to disengage the teeth between the top ledge of the slot and the shoulder of the enlarged end of the movable pin 67 and then the control knob 68 is rotated. The movable pin 67 is urged to slide along the spiraling track 70 thereby changing its distance from the center of the disc 64. The oscillation angle will thereby be changed accordingly.

FIGS. 113 and 114 show another variation of the embodiment of the adjustable mechanism shown in FIGS. 108, 109, and 110. In this embodiment, a normally free rotating control knob 71 is rotably connected to the top of the vertical axle 20. The control knob 71 normally does not rotate with the vertical axle 20 but is connected to the vertical axle 20 such that when it is moved upward or alternatively downward, it can engage the vertical axle 20 to enable the control knob 71 to rotate the vertical axle 20. This may be accomplished with a variety of well known designs. One such design is to have a symmetrical geometric shape such as gear teeth at the top extremity of the vertical axle 20 which may be engaged by corresponding symmetrical geometric shaped cavity such as a gear cavity at the bottom of the control knob 71, or vice versa. A spring may optionally be utilized to ensure that the gear teeth and the gear cavity remain separated until force is applied to the control knob 71 to engage them. A disc 64 is affixed to the bottom end of the vertical axle 20. The disc 64 has an elongated slot 65 oriented radially from the center of the disc 64 to near the edge of the disc 64. The top surface of the slot 65 has teeth formed to match corresponding teeth on the top end of the movable pin 67. The movable pin 67 has a top end with teeth that engage the teeth in the top surface of the slot 65 in the disc 64 and is slidable within the elongated slot 65 when the teeth are disengaged. A control surface 69 is positioned under the movable pin 67. The control surface 69 has a spiral track 70 with a shelf near its open top. The bottom end of the movable pin 67 has a larger end that fits inside the spiral track 70 but is larger than the shelf such that it cannot be pulled out of the track 70 from the top and is slidably positioned within the spiral track 70. To move the movable pin 67, the control knob 71 is first pulled up to disengage the teeth at the top end of the movable pin 67 and then the control knob 71 is rotated. The movable pin 67 is urged to slide along the spiraling track 70 thereby changing its distance from the center of the disc 64. The oscillation angle will thereby be changed accordingly. Alternatively, the disc 64 may be replaced with an elongated member with a similar elongated slot 65 as the disc 64. The other components remain unchanged and are structured in the same way.

In an alternate embodiment, instead of positioning the teeth on the top surface of the slot 65, the teeth are positioned at the bottom ledge of the slot 65 to match corresponding teeth on the top end of the movable pin 67. The movable pin 67 has an enlarged top end with teeth at the shoulder of the enlarged end to engage the teeth at the bottom ledge of the slot 65 in the disc 64 and is slidable within the elongated slot 65 when the teeth are disengaged. To move the movable pin 67, the control knob 71 is first pushed down to disengage the teeth between the bottom ledge of the slot 65 and the shoulder of the enlarged end of the movable pin 67 and then the control knob 71 is rotated. The movable pin 67 is urged to slide along the spiraling track 70 thereby changing its distance from the center of the disc 64. The oscillation angle will thereby be changed accordingly.

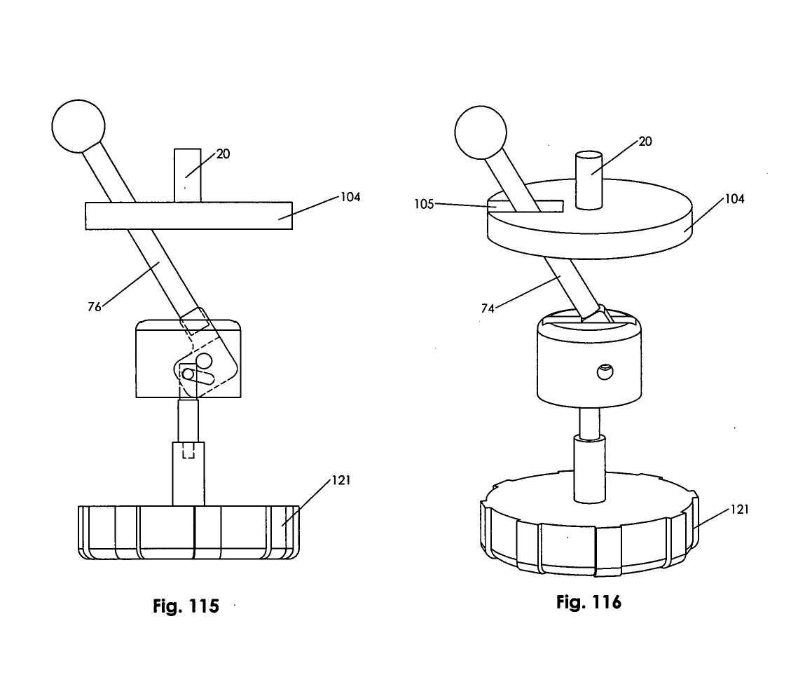

FIGS. 115 and 116 show another variation of the embodiment of the adjustable mechanism shown in FIGS. 40, 41, and 42. In this embodiment, a disc 104 is affixed to the bottom end of the vertical axle 20. The disc 104 may also be replaced with a simple elongated arm that extends from the bottom end of the vertical axle 20. A linear radial slot 105 is formed in the disc 104 or the elongated arm, whichever embodiment is utilized. A movable pin 74 is pivotally connected to the top of a control knob such that as the control knob is moved up and down in its axial direction, the movable pin 74 will pivot and change the distance between its extremity and the center of the vertical axle 20 thereby changing the oscillation angle. The other end of the movable pin 74 is slidably engaged in the slot 105 in the disc 104 or the elongated arm. The pivoting arm 14 is slidably engaged to the movable pin 74 at a position between the disc 104 or the elongated arm and the pivot point of the movable pin 74. As the control knob 121 is moved up, the distance between the extremity of the movable pin 74 and the vertical axle 20 is reduced, thereby reducing the oscillation angle. As the control knob 121 is moved down, the distance between the extremity of the movable pin 74 and the vertical axle 20 is increased, thereby increasing the oscillation angle. This may be reversed by simply moving the position of the connection of the control knob 121 with respect to the pivot point. By moving the position of the connection of the control knob 121 to the other side of the pivot point, as the control knob 121 is moved up, the distance between the extremity of the movable pin 74 and the vertical axle 20 is increased, thereby increasing the oscillation angle. As the control knob 121 is moved down, the distance between the extremity of the movable pin 74 and the vertical axle 20 is decreased, thereby reducing the oscillation angle.

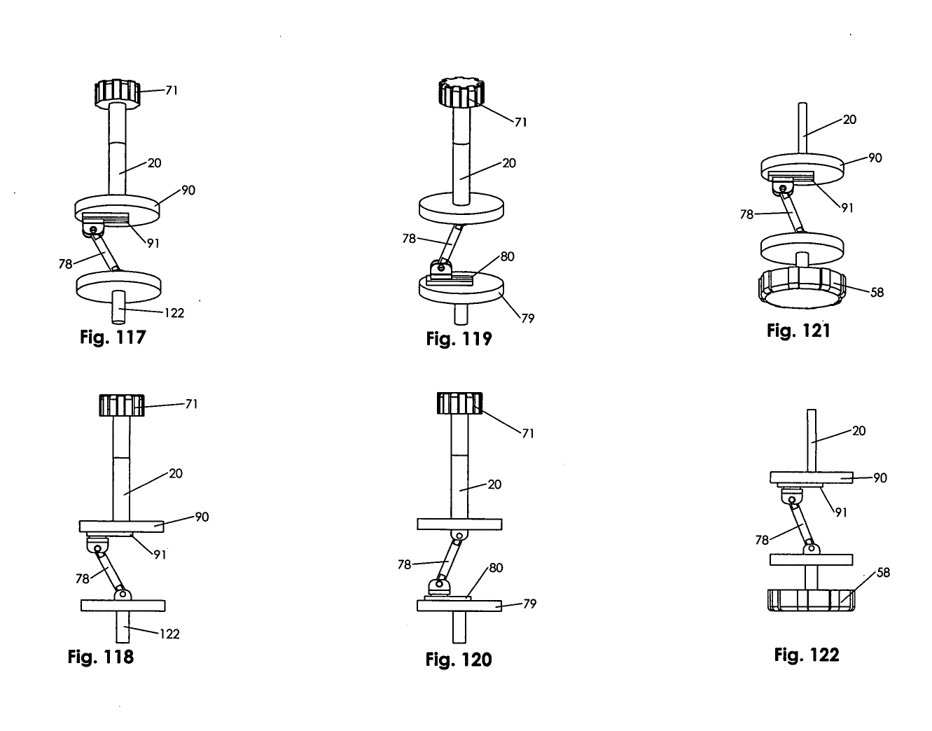

FIGS. 117 and 118 show another variation of the embodiment of the adjustable mechanism shown in FIGS. 43, 44, and 45. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A disc 90 is affixed to the bottom end of the vertical axle 20. The disc 90 may also be replaced with a simple elongated arm that extends from the bottom end of the vertical axle 20. A linear radial track 91 is formed in the disc 90 or the elongated arm, whichever embodiment is utilized. A movable pin 78 is pivotally connected at its bottom end to a free rotating axle 122 aligned with the vertical axle 20 and positioned under the vertical axle 20. The top end of the movable pin 78 is slidably engaged in the linear radial track 91 in the disc 90 or the elongated arm. As the vertical axle 20 is moved up and down in its axial direction, the movable pin 78 will pivot and change the distance between it and the center of the vertical axle 20 thereby changing the oscillation angle. As the vertical axle 20 is pulled up by the control knob 71, the distance between the top of the movable pin 78 and the vertical axle 20 is reduced, thereby reducing the oscillation angle. As the vertical axle 20 is pushed down by the control knob 71, the distance between the top of the movable pin 78 and the vertical axle 20 is increased, thereby increasing the oscillation angle. When the top of the movable pin 78 is positioned directly under the vertical axle 20, the oscillation angle is reduced to zero, thereby essentially stopping the oscillation of the fan.

FIGS. 119 and 120 show another variation of the embodiment of the adjustable mechanism shown in FIGS. 117 and 118. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A movable pin 78 is pivotally connected to the bottom of the vertical axle 20. The bottom end of the movable pin 78 is slidably engaged in a linear radial track 80 in a free rotating disc 79 or a free rotating elongated arm positioned under the vertical axle 20. As the vertical axle 20 is moved up and down in its axial direction, the movable pin 78 will pivot and change the distance between it and the center of the vertical axle 20 thereby changing the oscillation angle. As the vertical axle 20 is pulled up by the control knob 71, the distance between the bottom of the movable pin 78 and the vertical axle 20 is reduced, thereby reducing the oscillation angle. As the vertical axle 20 is pushed down by the control knob 71, the distance between the bottom of the movable pin 78 and the vertical axle 20 is increased, thereby increasing the oscillation angle. When the bottom of the movable pin 78 is positioned directly under the vertical axle 20, the oscillation angle is reduced to zero, thereby essentially stopping the oscillation of the fan.

A variation of the embodiment shown in FIGS. 49, 50, and 51 is shown in FIGS. 121 and 122. In this embodiment, a disc 90 is affixed to the bottom end of the vertical axle 20. The disc 90 may also be replaced with a simple elongated arm that extends from the bottom end of the vertical axle 20. A linear radial track 91 is formed in the disc 90 or the elongated arm, whichever embodiment is utilized. A movable pin 78 is pivotally connected at its bottom end to a control knob 58 positioned under the vertical axle 20. The top end of the movable pin 78 is slidably engaged in the linear radial track 91 in the disc 90 or the elongated arm. The bottom end of the movable pin 78 can be moved up or down with the control knob 58. The movement may be by rotating the control knob 58 which may have a screw-type stem that rotates in a fixed hole with matching screw threads to advance or retract the bottom end of the movable pin 78. As the bottom end of the movable pin 78 is raised, the top end of the movable pin 78 is urged away from the center of the vertical axle 20. As the bottom end of the movable pin 78 is lowered, the top end of the movable pin 78 is pivoted towards the center of the vertical axle 20. The oscillation angle will thereby be changed accordingly.

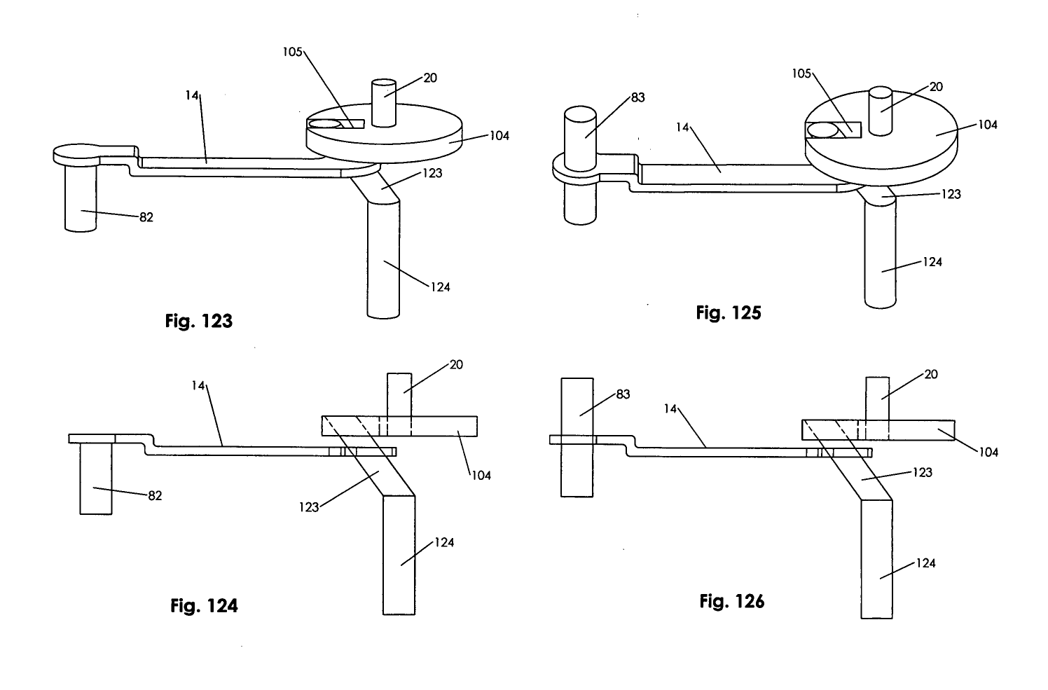

A variation of the embodiment shown in FIGS. 52 and 53 is shown in FIGS. 123 and 124. In this embodiment, a disc 104 is affixed to the bottom end of the vertical axle 20. The disc 104 may also be replaced with a simple elongated arm that extends from the bottom end of the vertical axle 20. A linear radial slot 105, a track, or a linear protrusion is formed on the disc 104 or the elongated arm, whichever embodiment is utilized. A short section 123 of the top end of a free rotating elongated member 124 is bent at an angle. An end of the pivoting arm 14 has an opening that slides over this short angle section 123 of the free rotating elongated member 124. The other end of the pivoting arm 14 is affixed to a movable member 82 that may be moved up or down to slide the pivoting arm 14 along the short angle section 123 of the free rotating elongated member 124. Since the short angle section 123 of the free rotating elongated member 124 is at an angle relative to the axis of the vertical axle 20, as the pivoting arm 14 is moved up or down on the short angle section 123, the distance from the end of the pivoting arm 14 to the center of the vertical axle 20 is changed, thereby changing the oscillating angle. Alternatively, with the linear radial slot 105 in the disc 104 or elongated arm, the free rotating elongated member 124 may be moved up or down while the other end of the pivoting arm 14 is affixed at a fixed location. A structure similar to the structure disclosed previously with a free rotating control knob 71 that is rotably connected to the top of the vertical axle 20 may be employed. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. As the vertical axle 20 is moved up or down the pivoting arm 14 is moved to different positions along the angled section 123 of the free rotating elongated member 124, the relative position of the pivoting arm 14 to the center of the vertical axle 20 is changed, thereby changing the oscillating angle.

A variation of the embodiment shown in FIGS. 123 and 124 is shown in FIGS. 125 and 126. In this embodiment, a disc 104 is affixed to the bottom end of the vertical axle 20. The disc 104 may also be replaced with a simple elongated arm that extends from the bottom end of the vertical axle 20. A linear radial slot 105, a track, or a linear protrusion is formed on the disc 104 or the elongated arm, whichever embodiment is utilized. A short section 123 of the top end of a free rotating elongated member 124 is bent at an angle. An end of the pivoting arm 14 has an opening that slides over this short angle section 123 of the free rotating elongated member 124. The other end of the pivoting arm 14 has another opening that slides vertically over another vertical elongated member 83. The entire pivoting arm 14 may be moved up or down to slide the pivoting arm 14 along the short angle section 123 of the free rotating elongated member 124. Since the short angle section 123 of the free rotating elongated member 124 is at an angle relative to the axis of the vertical axle 20, as the pivoting arm 14 is moved up or down on the short angle section 123, the distance from the end of the pivoting arm 14 to the center of the vertical axle 20 is changed, thereby changing the oscillating angle. The pivoting arm 14 may be moved with a telescoping member that holds the pivoting arm 14 at a location between the two ends of the pivoting arm 14. The pivoting arm 14 may also be moved by an elongated member with one end affixed to a point between the two ends of the pivoting arm 14. When the elongated member is moved in the vertical direction, the pivoting arm 14 will also be moved along the short angle section 123 of the free rotating elongated member 124.

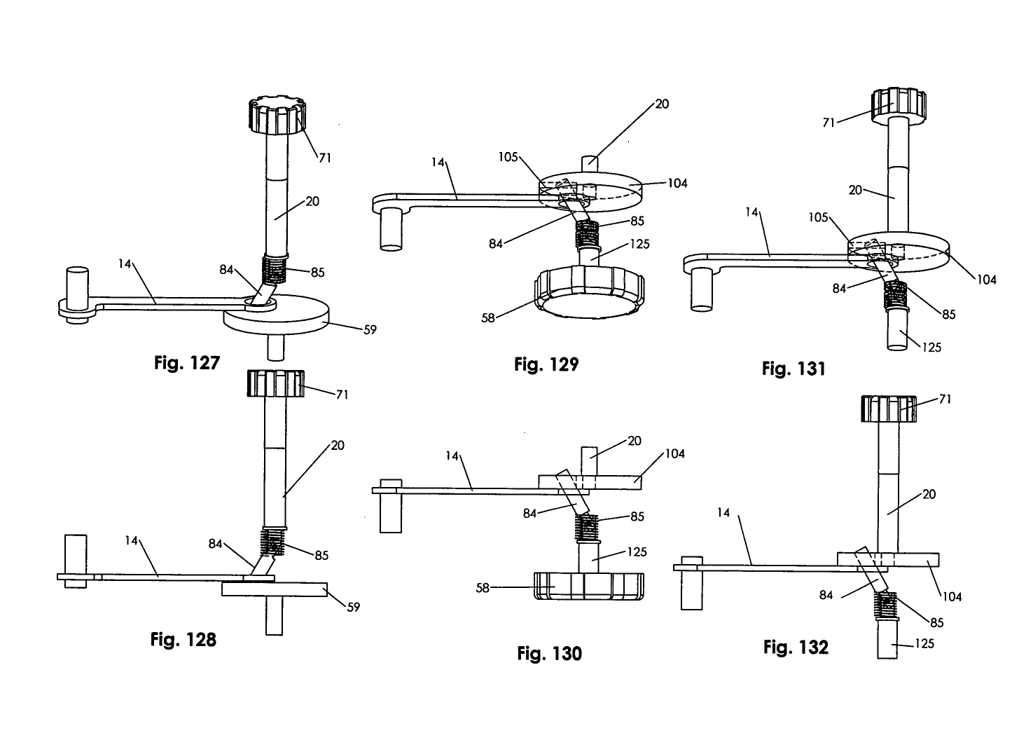

A variation of the embodiment shown in FIGS. 56 and 57 is shown in FIGS. 127 and 128. In this embodiment, a short elongated member 84 is pivotally connected to the bottom of the vertical axle 20 such that the short elongated member 84 can pivot and change the distance between its extremity and the center of the vertical axle 20 thereby changing the oscillation angle. A spring 85 is positioned around the end of the vertical axle 20 resting against the short elongated member 84 and exerting a force against the short elongated member 84 urging it towards the vertical position. The spring 85 or another urging means may be positioned in any convenient location to providing the force to urge the short elongated member 84 towards the vertical position. A free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A fixed control surface 59 is positioned under the short elongated member 84 with the short elongated member 84 in contact with the control surface 59. The control surface 59 may be a flat planar surface. As the vertical axle 20 is raised, the end of the short elongated member 84 is urged to pivot towards the center of the vertical axle 20. As the vertical axle 20 is lowered, the end of the short elongated member 84 is pivoted away from the center of the vertical axle 20. The oscillation angle will thereby be changed accordingly.

Another variation of the embodiment shown in FIGS. 56 and 57 is shown in FIGS. 129 and 130. A disc 104 is affixed to the bottom end of the vertical axle 20. The disc 104 may also be replaced with a simple elongated arm that extends from the bottom end of the vertical axle 20. A linear radial slot 105, a track, or a linear protrusion is formed on the disc 104 or the elongated arm, whichever embodiment is utilized. A short elongated member 84 is pivotally connected to a control member 125 with a control knob 58 positioned under the vertical axle 20. A spring 85 is positioned around the end of the control member 125 resting against the short elongated member 84 and exerting a force against the short elongated member 84 urging it towards the vertical position. The spring 85 or another urging means may be positioned in any convenient location to providing the force to urge the short elongated member 84 towards the vertical position. The control member 125 can be moved up or down with the control knob 58. The movement may be by rotating the control knob 58 which may have a screw-type stem that rotates in a fixed hole with matching screw threads to advance or retract the control member 125 against the short elongated member 84. As the control member 125 is raised, the end of the short elongated member 84 is urged to pivot away from the center of the vertical axle 20. As the control member 125 is lowered, the end of the short elongated member 84 is pivoted towards the center of the vertical axle 20. The oscillation angle will thereby be changed accordingly.

Another variation of the embodiment shown in FIGS. 56 and 57 is shown in FIGS. 131 and 132. A free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A disc 104 is affixed to the bottom end of the vertical axle 20. The disc 104 may also be replaced with a simple elongated arm that extends from the bottom end of the vertical axle 20. A linear radial slot 105, a track, or a linear protrusion is formed on the disc 104 or the elongated arm, whichever embodiment is utilized. A short elongated member 84 is pivotally connected to a free rotating vertical member 125 positioned under the vertical axle 20. A spring 85 is positioned around the end of the free rotating vertical member 125 resting against the short elongated member 84 and exerting a force against the short elongated member 84 urging it towards the vertical position. The spring 85 or another urging means may be positioned in any convenient location to providing the force to urge the short elongated member 84 towards the vertical position. As the vertical axle 20 is raised, the end of the short elongated member 84 is urged by the spring 85 to pivot towards the center of the vertical axle 20. As the vertical axle 20 is lowered, the end of the short elongated member 84 is pivoted away from the center of the vertical axle 20. The oscillation angle will thereby be changed accordingly.

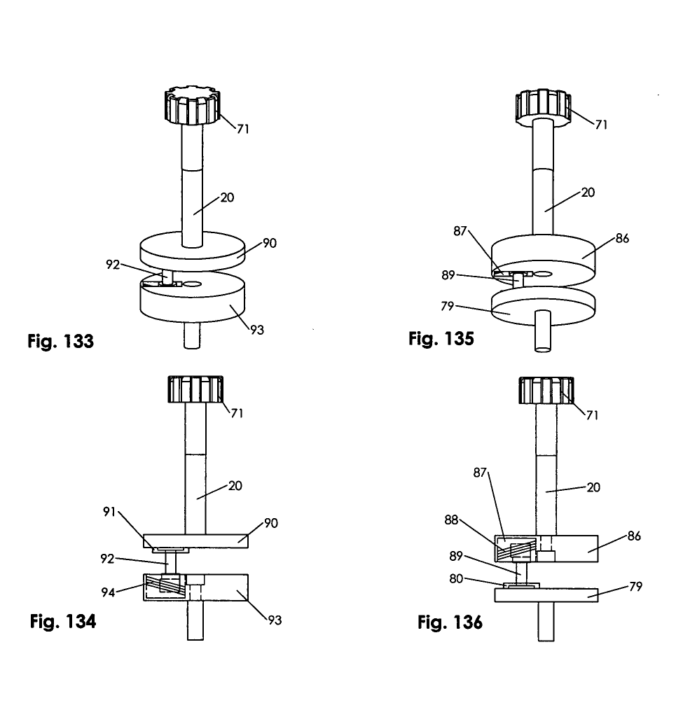

A variation of the embodiment of the adjustable mechanism shown in FIGS. 61, 62, and 63 is shown in FIGS. 133 and 134. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A disc 90 is affixed to the bottom end of the vertical axle 20. The disc 90 has a linear radial track 91. Alternatively, the disc 90 may be replaced with an elongated member with a linear radial track. The movable pin 92 has a top end that is slidably engaged to the track 91. A control surface 93 is positioned under the movable pin 92. The bottom end of the movable pin 92 is slidably engaged to a slanted track 94 oriented radially in the control surface 93 and tapering upward from the center of the control surface 93 to the edge of the control surface 93. As the vertical axle 20 is lowered, the movable pin 92 is urged toward the center of the disc 93 due to the slanted track 94. As the vertical axle 20 is raised, the movable pin 92 will move towards the edge of the disc 93. The oscillation angle will thereby be changed accordingly.

A variation of the embodiment of the adjustable mechanism shown in FIGS. 58, 59, and 60 is shown in FIGS. 135 and 136. In this embodiment, a free rotating control knob 71 is rotably connected to the top of the vertical axle 20, similar to the structure disclosed in FIGS. 40, 41, and 42. The control knob 71 does not rotate with the vertical axle 20 but is connected to the vertical axle 20 such that it can move the vertical axle 20 up and down in its axial direction. This may be accomplished with an enlarged circular terminal in the form of a sphere or a disc at the top extremity of the vertical axle 20 which is received in a corresponding cavity at the bottom of the control knob 71. A disc 86 is affixed to the bottom end of the vertical axle 20. The disc 86 has an elongated slot 87 with a slanted track 88 tapering downward from the center of the disc 86 toward the edge of the disc 86. Alternatively, the disc 86 may be replaced with an elongated member with an elongated slot with a slanted track. The movable pin 89 has a top end that is slidably engaged to the track 88 in the elongated slot 87. A control surface 79 is positioned under the movable pin 89. The bottom end of the movable pin 89 is slidably engaged to a linear track 80 oriented radially in the control surface 79. As the vertical axle 20 is lowered, the movable pin 89 is urged toward the center of the disc 86 due to the slanted track 88 in the elongated slot 87. As the vertical axle 20 is raised, the movable pin 89 will move towards the edge of the disc 79. The oscillation angle will thereby be changed accordingly.

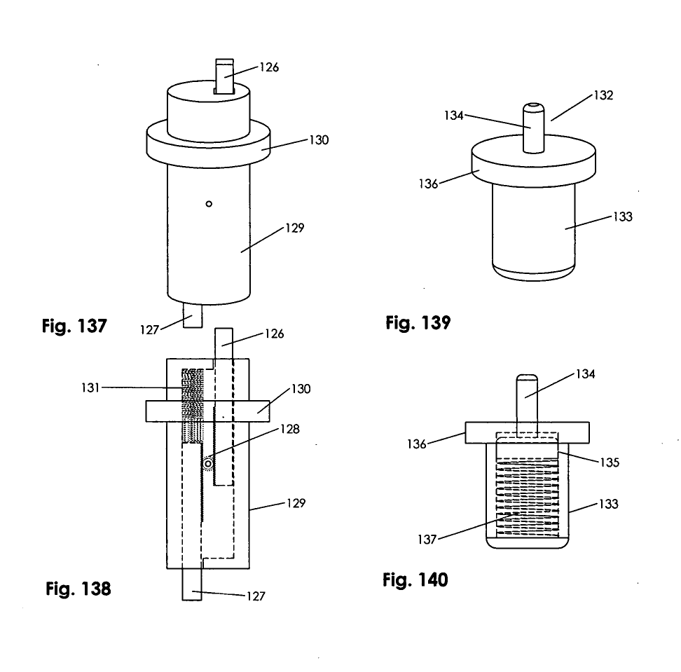

FIGS. 137 and 138 shows an alternate embodiment of the movable pin. In this embodiment, the movable pin comprises of two plungers 126, 127 engaged to a gear 128 and disposed in a cylindrical housing 129 with a ring of protrusion 130. One end of the first plunger 126 extends out of the top of the cylindrical housing 129. Gear teeth are provided near the other end of the first plunger 126. A gear 128 is affixed inside the cylindrical housing 129 and engages the gear teeth on the first plunger 126. An end of the second plunger 127 extends out of the bottom of the cylindrical housing 129. Gear teeth are provided near the other end of the second plunger 127 and engage the gear 128 in the cylindrical housing 129. A spring 131 is disposed in the cylindrical housing 129 and positioned between the end of the second plunger 127 inside the cylindrical housing 129 and an end of the cylindrical housing 129. The spring 131 provides a constant urging force to extend the plungers 126, 127 outside of the cylindrical housing 129. Alternatively the spring 131 may be positioned between the end of the first plunger 126 inside the cylindrical housing 129 and an end of the cylindrical housing 129. This embodiment of the movable pin enables the top plunger 126 to be retracted by pushing up on the bottom plunger 127. This embodiment of the movable pin may be alternatively used in the embodiment of the adjustable mechanism shown in FIGS. 3 through 6, 7 through 9, 13 through 15, and 80 through 83 where the movable pin is utilized.

FIGS. 139 and 140 shows another embodiment of the movable pin. In this embodiment, the movable pin comprises of a cylindrical plunger 132 disposed in a cylindrical housing 133. The plunger 132 comprises a cylindrical protrusion 134 and a disc 135 affixed to one end. The cylindrical housing 133 comprises a cylinder with first sealed end and a second end with a disc 136 that has a larger diameter than the outside diameter of the cylindrical housing 133 affixed to the second end. The disc 136 has an opening in the center slightly larger than the outside diameter of the cylindrical protrusion 134 in the plunger 132. The plunger 132 is disposed inside the cylindrical housing 133 with the cylindrical protrusion 134 extending through the opening in the center of the disc 136. A spring 137 is disposed in the cylindrical housing 133 positioned between the disc 135 at the end of the plunger 132 and the sealed end of the cylindrical housing 133. The plunger 132 can be pressed into the cylindrical housing 133 and upon release of the pressure, the plunger 132 will move back out of the cylindrical housing 133 until the disc 135 affixed to the end of the plunger 132 contacts the disc 136 affixed to the end of the cylindrical housing 133. This embodiment of the movable pin may be alternatively used in the embodiment of the adjustable mechanism shown in FIGS. 3 through 6, 7 through 9, 13 through 15, and 80 through 83 where the movable pin is utilized.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An adjustable mechanism to change the oscillating angle of an adjustable angle fan comprising:
a first disc with multiple posts and multiple positioning posts;
a second disc and with an offset circulating track that has multiple holes in said offset circular track and multiple positioning holes positioned opposite said first disc wherein said multiple posts extend into the multiple holes and said multiple positioning posts extend into said multiple positioning holes;
an urging means mounted between the two discs urging the separation of the two discs; and
a movable pin insertable into said multiple holes in said offset circular track and slidable within the circular track.

2. An adjustable mechanism to change the oscillating angle of an adjustable angle fan as in claim 1, wherein an actuating arm is positioned to urge said first disc and said second disc together.

3. An adjustable mechanism to change the oscillating angle of an adjustable angle fan as in claim 1, wherein a pivoting arm is positioned such that it constantly exerts a force on the movable pin to maintain the movable pin within the circular track.

4. An adjustable mechanism to change the oscillating angle of an adjustable angle fan comprising a disc with an offset circular track on a bottom surface of said disc and multiple holes extending through said disc from said circular track.

5. An adjustable mechanism to change the oscillating angle of an adjustable angle fan as in claim 4, wherein a section of the circular track that leads from one hole to the next hole is tapered.

6. An adjustable mechanism to change the oscillating angle of an adjustable angle fan comprising:
a disc with an offset circular track on a bottom surface of said disc and a gear surface on a wall of said circular track; and
a movable pin with matching gear teeth to the gear surface on said wall of said circular track.

7. An adjustable mechanism to change the oscillating angle of an adjustable angle fan comprising:
a first disc with a track in the form of an arc or a spiral on a bottom surface of said first disc;
a second disc with a track and rotably affixed rotably opposite the first disc; and
a movable pin slidably retained within said track in said second disc.

8. An adjustable mechanism to change the oscillating angle of an adjustable angle fan comprising:
a member with a through hole that has a gear-shaped cavity;
a small gear that engages said gear-shaped cavity in said through hole;
a large gear rotably affixed to a surface of said member and engages said small gear; and
a movable pin affixed to said large gear at an offset location away from the center of said large gear.

9. An adjustable mechanism to change the oscillating angle of an adjustable angle fan comprising:
a member with a radial slot track that has a rack gear on one side of said radial slot track; and
a movable pin with a pinion gear engaged to said rack gear in said radial slot track.

10. An adjustable mechanism to change the oscillating angle of an adjustable angle fan comprising:
a member with a through hole that has a gear-shaped cavity;
a small gear that engages said gear-shaped cavity in said through hole;
a gear rack affixed to a surface of said member and engages said small gear; and
a movable pin affixed to said gear rack.

11. An adjustable mechanism to change the oscillating angle of an adjustable angle fan comprising:
a member with an elongated slot with two ends and with a slanted top surface;
a movable pin with a top end that is slidably positioned within said elongated slot and slides on said slanted top surface in said elongated slot;
a spring disposed between the top end of said movable pin and one end of the elongated slot to provide an urging force against said movable pin;
a surface positioned under said movable pin; and
an adjustment means wherein the distance between said member and said surface may be varied.

12. An adjustable mechanism to change the oscillating angle of an adjustable angle fan as in claim 11, wherein said surface further comprising a slot or a track on said surface.

13. An adjustable mechanism to change the oscillating angle of an adjustable angle fan comprising:
a member with an elongated slot wherein said elongated slot has multiple protrusions and recesses;
a movable pin with corresponding protrusions and recesses on a first end of said movable pin wherein said movable pin is slidable within said elongated slot and a second end;
a surface positioned adjacent to said second end of said movable pin; and
an adjustment means wherein the distance between said member and said surface may be varied.

14. An adjustable mechanism to change the oscillating angle of an adjustable angle fan as in claim 13, wherein said second end of said movable pin is slidably engaged to a spiral track in said surface.

15. An adjustable mechanism to change the oscillating angle of an adjustable angle fan comprising:
a control knob rotably connected to a first end of a vertical axle; and
a movable pin pivotally connected to a second end of said vertical axle;
wherein when said vertical axle is moved up and down in its axial direction, said movable pin will pivot.

16. An adjustable mechanism to change the oscillating angle of an adjustable angle fan comprising:
a member with a slot; and
a movable pin with a first end pivotally connected to a control means and a second end slidably engaged in said slot in said member;
wherein when said control means is moved up or down, said movable pin will pivot.

17. An adjustable mechanism to change the oscillating angle of an adjustable angle fan comprising:
a control knob rotably connected to a first end of a vertical axle;
a movable pin pivotally connected to a second end of said vertical axle; and
a pivoting arm connects to said movable pin and maintains the vertical position of said movable pin.

18. An adjustable mechanism to change the oscillating angle of an adjustable angle fan comprising:
a movable pin pivotally connected to a vertical axle;
a pivoting arm connects to said movable pin; and
a movable surface positioned in constant contact with an end of said movable pin.

19. An adjustable mechanism to change the oscillating angle of an adjustable angle fan as in claim 18, wherein a track oriented radially is positioned on said surface and wherein said end of said movable pin slidably engages in the track on said surface.

20. An adjustable mechanism to change the oscillating angle of an adjustable angle fan comprising:
an elongated member with a short end section formed at an angle;
an end of a pivoting arm slidably engages said short end section of said elongated member; and
an actuating means connected to said pivoting arm to move said movable arm along the length of said short end section of said elongate member.

21. An adjustable mechanism to change the oscillating angle of an adjustable angle fan as in claim 20, wherein said actuating means is connected to a second end of said pivoting arm to move said movable arm along the length of said short end section of said elongate member.

22. An adjustable mechanism to change the oscillating angle of an adjustable angle fan comprising:
a vertical member;
a short elongated member pivotally connected to said vertical member;
an urging means providing a force to urge said short elongate member towards the vertical position;
a surface positioned in contact with said short elongated member; and
a moving means to vary the distance between said vertical member and said surface.

23. An adjustable mechanism to change the oscillating angle of an adjustable angle fan comprising:
a first member with an elongated slot with a slanted track;
a movable pin with a first end that is slidably engaged to said slanted track in said elongated slot;
a surface disposed under a second end of said movable pin wherein said second end of said movable pin is slidably engaged in a linear track on said surface; and
a moving means to vary the distance between said first member and said surface.

24. An adjustable mechanism to change the oscillating angle of an adjustable angle fan comprising:
a housing;
a vertical member disposed in said housing with a flexible curved section that can retract and extend from said housing; and
a moving means to retract and extend said vertical member.

25. An adjustable mechanism to change the oscillating angle of an adjustable angle fan as in claim 24, wherein a movable pin is pivotally connected to the terminal of said flexible curved section.

26. An adjustable mechanism to change the oscillating angle of an adjustable angle fan comprising:
a vertical member with a flexible curved section;
a surface disposed against said flexible curved section of said vertical member; and
a moving means to vary the distance between said vertical member and said surface.

27. An adjustable mechanism to change the oscillating angle of an adjustable angle fan as in claim 26, wherein a movable pin is pivotally connected to the terminal of said flexible curved section of said vertical member.

28. An adjustable mechanism to change the oscillating angle of an adjustable angle fan as in claim 26, wherein an end of said flexible curved section is slidably engaged in a track on said surface.

29. An adjustable mechanism to change the oscillating angle of an adjustable angle fan comprising:
a vertical member with a curved section;
a member with a slot disposed adjacent to said curved section of said vertical member with said curved section slidably engaged in said slot; and
a moving means to vary the distance between said vertical member and said member.
